(19) United States
(12) Patent Application Publication
(10) Pub. No.: US 2026/0030649 A1
(43) Pub. Date: Jan. 29, 2026

(54) OPEN-LOOP AND CLOSED-LOOP TRANSACTION FLEXIBILITY PROVIDED BY A TRANSACTION-SETTLEMENT PROCESSING SYSTEM

(71) Applicant: Mudflap, Inc., Palo Alto, CA (US)

(72) Inventors: Piers Rollinson, Henderson, NV (US); Peter O’Leary, San Francisco, CA (US); Seth Levy, Oakland, CA (US); Sharon Yapp, Campbell, CA (US); Jonathan Kassan, Carlsbad, CA (US)

(21) Appl. No.: 18/785,989

(22) Filed: Jul. 26, 2024

(51) Int. Cl. G06Q 30/0207; G06Q 30/0238; G06Q 30/0283

(52) U.S. Cl. CPC G06Q 30/0215; G06Q 30/0238; G06Q 30/0283

(57) ABSTRACT

A system is capable of settling both open-loop and closed-loop transactions originating at merchant systems. The system is configured to accept open-loop transactions using a payment network and for accepting closed loop transaction using a one-time use token generated by the system. The system is configured to settle transactions by applying discounts after final transaction data is generated—the discount may be determined for either closed-loop or open-loop transactions before deducting a discounted value from a purchaser's account.

### BACKGROUND

Payment processors for fuel purchases (e.g., vehicle fuel, such as diesel fuel for long-haul truckers) have historically offered minimal flexibility for purchasers to carry out transactions with fueling stations. While some fueling stations (merchants) may offer discounts to certain purchasers, those purchasers must follow a specific set of steps to ensure the fueling station provides the maximum discount to the purchaser. Often times these steps require the purchaser to execute separate transactions for products that are discounted (e.g., fuel) and those products that are not discounted. This has been a limitation of payment processors, which do not receive sufficiently rich data to distinguish between those products that are discounted and those products that are not discounted. Moreover, payment processors are limited to a single transaction channel, in part because payment processors are limited to accepting payments for transactions that are executed by legacy point-of-sale (POS) systems at fueling stations.

Therefore, a need exists for payment processing systems capable of accepting transaction data from a plurality of transaction channel types to provide greater flexibility to purchasers and merchants in customizing transaction offerings.

### BRIEF SUMMARY

Certain embodiments are directed to a method for settling transactions using a multi-channel transaction settlement system. In various embodiments, the method comprises: generating, using one or more processors, a single-use token for a purchaser account, wherein the single-use token identifies a discount amount for a closed-loop transaction; receiving, using the one or more processors, first transaction data using a closed-loop transaction channel, wherein the first transaction data comprises the single-use token; generating, using the one or more processors, first settlement data at least in part by retrieving purchaser account data from the purchaser account based at least in part on the single-use token and populating the first settlement data having a format for a financial system; transmitting, using the one or more processors, the first settlement data to the financial system to cause funding to be transferred from the first funding account to a second funding account; receiving, using the one or more processors, second transaction data using an open-loop transaction channel in communication with a payment network, wherein the second transaction data comprises a payment instrument identifier linked with the purchaser account; generating, using the one or more processors, second settlement data at least in part by populating the second settlement data from the second transaction data into a format for the financial system; and transmitting, using the one or more processors, the second settlement data to the financial system to cause funding to be transferred from the first funding account to the second funding account.

In various embodiments, the method further comprises generating the first transaction data based at least in part on user input received from a merchant computing entity as a part of the closed-loop transaction. In some embodiments, the first settlement data comprises authorization data indicating the first settlement data is authorized for transferring funds from the first funding account associated with the purchaser account. In various embodiments, the second transaction data is received using an open-loop transaction channel in communication with a payment network by an application programming interface (API). In certain embodiments, the second transaction data comprises L2 data from a payment instrument having the payment instrument identifier. According to various embodiments, the first settlement data comprises a transaction type identifier reflecting a closed-loop transaction type and the second settlement data comprises a transaction type identifier comprises a transaction type identifier reflecting an open-loop transaction type. In certain embodiments, the method further comprises, after receipt of the first transaction data or receipt of the second transaction data, verifying funding within the first funding account; and upon determining the first funding account has insufficient funds to satisfy the first transaction data or the second transaction data, causing the financial system to initiate funding into the first funding account from an external account.

Certain embodiments are directed to a multi-channel transaction settlement system comprising: a single-use token generator for closed-loop transactions, wherein the single-use token generator links a single-use token with a purchaser account stored in memory of the multi-channel transaction settlement system; a closed-loop transaction channel linked with one or more processors, configured to: receive first transaction data comprising the single-use token; generate first settlement data at least in part by retrieving purchaser account data from the purchaser account based at least in part on the single-use token and populating the first settlement data having a format for a financial system, wherein the first settlement data identifies a first financial account based at least in part on the purchaser account; an open-loop transaction channel linked with the one or more processors, configured to: receive second transaction data comprising a payment instrument identifier of a payment instrument of the purchaser; generate second settlement data at least in part by populating the second settlement data from the second transaction data into a format for the financial system, wherein the second settlement data identifies the first financial account based at least in part on the purchaser account; a financial system channel linked with the one or more processors, configured to transmit the first settlement data and the second settlement data to a financial system to cause the financial system to transfer first funds from the first financial account to a second financial account for the first settlement data and to transfer second funds from the first financial account to the second financial account for the second settlement data.

In certain embodiments, the closed-loop transaction channel is configured to receive the first transaction data from a merchant computing system. In various embodiments, the open-loop transaction channel is configured to receive the second transaction data using an Application Program Interface (API) from a payment network. In various embodiments, the financial system channel is configured to pre-process the first transaction data and the second transaction data to populate at least a portion of the first settlement data and the second settlement data. In certain embodiments, the financial system channel is configured to encrypt the first settlement data and the second settlement data. In certain embodiments, the single-use token generator is configured to receive a token generation request from a purchaser computing entity, and wherein the single-use token is liked with the purchaser account based at least in part on the token generation request received from the purchaser computing entity. In various embodiments, the financial system channel is further configured to verify funding within the first financial account and to utilize one of the closed-loop transaction channel or the open-loop transaction channel to transmit authorization data based at least in part on results of the funding verification. In certain embodiments, the financial system channel is further configured to, upon determining that the first financial account has insufficient funds to satisfy the first transaction data or the second transaction data, cause the financial system to initiate funding into the first funding account from an external account. In various embodiments, the financial system channel is further configured to populate at least a portion of the first settlement data and the second settlement data with a transaction type identifier, wherein the first settlement data is populated with a transaction type identifier reflecting a closed-loop transaction type, and the second settlement data is populated with a transaction type identifier reflecting an open-loop transaction type.

Certain embodiments are directed to a computer program product comprising a non-transitory computer readable medium having computer program instructions stored therein, the computer program instructions, when executed by a processor, cause the processor to: generate a single-use token for a purchaser account, wherein the single-use token identifies a discount amount for a closed-loop transaction; receive first transaction data using a closed-loop transaction channel, wherein the first transaction data comprises the single-use token; generate first settlement data at least in part by retrieving purchaser account data from the purchaser account based at least in part on the single-use token and populating the first settlement data having a format for a financial system; transmit the first settlement data to the financial system to cause funding to be transferred from the first funding account to a second funding account; receive second transaction data using an open-loop transaction channel in communication with a payment network, wherein the second transaction data comprises a payment instrument identifier linked with the purchaser account; generate second settlement data at least in part by populating the second settlement data from the second transaction data into a format for the financial system; and transmit the second settlement data to the financial system to cause funding to be transferred from the first funding account to the second funding account.

In various embodiments, the computer program instructions, when executed by the processor, further cause the processor to transmit the first transaction data based at least in part on user input received from a merchant computing entity as a part of the closed-loop transaction. In certain embodiments, the first settlement data comprises authorization data indicating the first settlement data is authorized for transferring funds from the first funding account associated with the purchaser account. In some embodiments, the second transaction data is received using an open-loop transaction channel in communication with a payment network by an application programming interface (API). In certain embodiments, the second transaction data comprises L2 data from a payment instrument having the payment instrument identifier. In various embodiments, the first settlement data comprises a transaction type identifier reflecting a closed-loop transaction type and the second settlement data comprises a transaction type identifier comprises a transaction type identifier reflecting an open-loop transaction type. In certain embodiments, the computer program instructions, when executed by the processor, further cause the processor to after receipt of the first transaction data or receipt of the second transaction data, verify funding within the first funding account; and upon determining the first funding account has insufficient funds to satisfy the first transaction data or the second transaction data, cause the financial system to initiate funding into the first funding account from an external account.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a system environment according to certain embodiments;

FIG. 2 is a schematic of an example remote computing entity according to certain embodiments;

FIG. 3 is a schematic of an example merchant system according to certain embodiments;

FIG. 4 illustrates example data stores within a remote computing entity according to certain embodiments;

FIG. 5 shows an example process flow of communications between entities according to certain embodiments;

FIGS. 6A-6B collectively show an example flowchart of a method for settling transactions using multiple payment channels according to certain embodiments.

FIG. 7 is a screenshot showing transaction data for a plurality of transactions, as visible within an executable application operating on a mobile device according to certain embodiments.

FIG. 8 is a screenshot showing transaction data for a plurality of transactions, as visible within an application accessible by a user device according to certain embodiments

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

As used herein, “fuel exchange” is a type of transaction that refers to an exchange of value between a merchant (specifically, a merchant embodied as a fuel exchange entity that sells fuel) and a purchaser for a fuel event. For example, a fuel exchange may include a transaction for purchase of an amount of fuel (e.g., diesel fuel) from a fuel entity to be provided to a fuel recipient, such as a vehicle driver, a long-haul trucker, and/or other purchaser, where the particular amount of fuel is associated with a fuel event comprising dispensing the fuel into a container and/or a vehicle of a purchaser. A fuel exchange (or any transaction) may be associated with an identifier, referred to as a fuel exchange identifier (or more generally, a transaction identifier), and metadata. Non-limiting examples of the metadata include timestamps, geolocation data, fuel type, fuel volume, identifiers for an associated merchant, purchaser, purchaser computing entity, payment network, and/or the like.

As used herein, “fuel event” refers to an instance in which an amount of fuel from a fuel entity is deposited into a vehicle or other container of a purchaser, or otherwise where an amount of fuel is sequestered from or reserved by the fuel entity on behalf of the purchaser. In one example, a fuel event includes a vehicle of a purchaser receiving an amount of diesel fuel from a fueling station that is associated with a merchant. In another example, a fuel event includes a purchaser, or agent of a fuel entity, dispensing an amount of fuel into a fuel container. A fuel event and/or fuel exchange may occur at a physical establishment associated with a merchant, such as a fuel depot, filling station, gas station, and/or the like. Additionally, or alternatively, a fuel event may occur at a first location and a fuel exchange may be initiated at a second location, which may be a physical location or a virtual location. A fuel event may be associated with one or more identifiers, referred to as fuel event identifiers, and metadata. Non-limiting examples of the metadata include timestamps, geolocation data associated with a location of the fuel event, fuel type, fuel exchange amount, identifiers for an associated merchant, purchaser, purchaser computing entity, and/or the like.

It should be understood that fuel types are not limited to diesel fuels. As used herein, fuels involved in a fuel event may encompass the non-limiting examples of diesel, biodiesel, unleaded gasoline, leaded gasoline, off-road rated diesel, off-road rated gasoline, ethanol, kerosene, propane, liquid hydrogen, fuel oil, and/or the like. For certain merchant/fuel stations capable of metering electricity as a fuel to be provided to a vehicle (or other electricity storage device), the embodiments discussed herein can be utilized for fuel exchange transactions for providing electrical power for storage in a vehicle or other storage device.

As used herein, a “fuel entity” refers to a type of merchant that is a provider of fuel. For example, a fuel entity may be a merchant, such as an owner and/or operator of a gas station. In another example, a fuel entity may be a wholesale supplier of fuel. In still another example, a fuel entity may be a third-party fuel broker. A fuel entity may be associated with one or more fueling locations at which fuel exchanges are initiated and/or fuel is provided to a purchaser. A fuel entity (or other merchant) may be associated with one or more identifiers, referred to as merchant identifiers and metadata. Non-limiting examples of the metadata include a location of the fuel entity, or fueling location associated therewith, data indicative of one or more instruments of exchange of a fuel entity (e.g., financial account numbers, routing numbers, payment instrument identifiers, etc.), legal name of a fuel entity, retail licensure data associated with the fuel entity, and/or the like. Similar metadata may be provided for other merchant types.

As used herein, “purchaser” (or “fuel recipient”) refers to any entity that enters into an exchange of value with a merchant, such as a fuel entity to obtain fuel. In one example, a purchaser may be an individual that obtains fuel for their vehicle from a filling station (e.g., the filling station being associated with a particular merchant/fuel entity). In another example, a purchaser may be a business or other organization that obtains or reserves fuel from a fuel depot or fuel supply network associated with a fuel entity. In some embodiments, a purchaser is associated with a purchaser computing entity. In various embodiments, the purchaser computing entity includes any computing device configured to communicate with the remote computing entity. For example, the purchaser computing entity may be a computing device configured to transmit single-use token request (also referred to as “fuel code request”) to and receive single-use tokens from the remote computing entity.

A single-use token (or a “fuel code”) is a numeric string that is generated by a remote computing entity and associated with a single purchaser's account. The single-use token may be presented by the purchaser during a transaction in place of a payment instrument. The single-use token may enable the remote computing entity to identify a purchaser eligible for the transaction, as well as additional transactions-specific data stored in memory for a transaction using the single-use token. For example, the single-use token may be stored with a unit price for products/services to be purchased (e.g., a per gallon price for fuel purchased from a particular merchant). The single-use token is linked with a single purchaser account, which enables the remote computing entity to identify a funding account that may be used for deducting funds to satisfy a transaction amount. In certain embodiments, the single-use token may have one or more usage limitations—such as merchant limitation that sets a single merchant as eligible for accepting the single-use token. Other usage limitations may comprise a timing limitation (e.g., the single-use token expires after a certain period of time). Although described here as being usable only a single time, certain tokens may be limited-use tokens, such as limited to use a maximum number of times (e.g., 2 times; 5 times; etc.), an unlimited number of times prior to an expiration date/time, and/or the like.

A closed-loop transaction is a transaction using electronic computing devices that each have software of a single entity, such as a remote computing entity. As an example, a closed-loop transaction may involve a remote computing entity and a separate computing device, such as a POS device having closed-loop transaction software installed at a merchant system. The separate computing device may also be referred to as an “edge” computing device, and a plurality of these edge computing devices (e.g., a plurality of merchant systems located at a plurality of merchant locations that may or may not be associated with one another, such as at different locations of the same merchant, or different merchants entirely) may all be connected with the remote computing entity, each forming a closed-loop system with the remote computing entity. Because each computing device involved in a closed-loop transaction has software of a sing entity (issuer), the entity need not share secrets or cryptographic keys with other entities when transferring data between entities. Moreover, the entity may shift certain data to storage at edge devices. For example, merchant account data may be stored at an edge device (e.g., a POS terminal, a mobile device connected with a POS terminal, and/or the like) associated with the merchant. In certain embodiments, a closed-loop transaction does not need external funding/payment information because purchasers and merchants using the closed-loop system provide payment information when registering and generating accounts. Accordingly, closed-loop transactions can occur using one-time use tokens as discussed above, and do not need to pass payment instrument data between the computing entities involved in the transaction.

An open-loop transaction is a transaction using a payment network that connects a POS terminal (which may or may not have performed prior transactions with an issuer/remote computing entity) with the issuer. A payment network may be any of a variety of known payment networks, including VISA®, MasterCard®, American Express®, and/or the like. An open-loop transaction may occur between any purchaser that has a payment instrument usable with the payment network (e.g., a VISA® branded credit card can be used at any merchant that accepts VISA® payment instruments). Therefore, the purchaser need not have an established account with the issuer/remote computing entity prior to initiating a transaction. Because the open-loop transaction occurs using a payment network, the issuer/remote computing entity does not utilize software installed on/at POS terminals, and therefore does not control how or when transaction data is transmitted to the remote computing entity.

### Computer Program Products, Methods, and Computing Entities

Embodiments of the present systems and methods for using multiple payment channels to settle a card-based transaction may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution). The terms software, computer program product, and similar words may be used herein interchangeably.

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile memory).

In one embodiment, a non-volatile computer-readable storage medium may include a floppy disk, flexible disk, hard disk, solid-state storage (SSS) (e.g., a solid state drive (SSD), solid state card (SSC), or solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-recordable (CD-R), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present techniques for fuel exchange authorization and optimization may also be implemented as methods, apparatus, systems, computing devices, computing entities, and/or the like. As such, embodiments of the present techniques for fuel exchange authorization and optimization may take the form of an apparatus, system, computing device, computing entity, and/or the like executing instructions stored on a computer-readable storage medium to perform certain steps or operations. Thus, embodiments of the present techniques for fuel exchange authorization and optimization may also take the form of an entirely hardware embodiment, an entirely computer program product embodiment, and/or an embodiment that comprises combination of computer program products and hardware performing certain steps or operations.

Embodiments are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

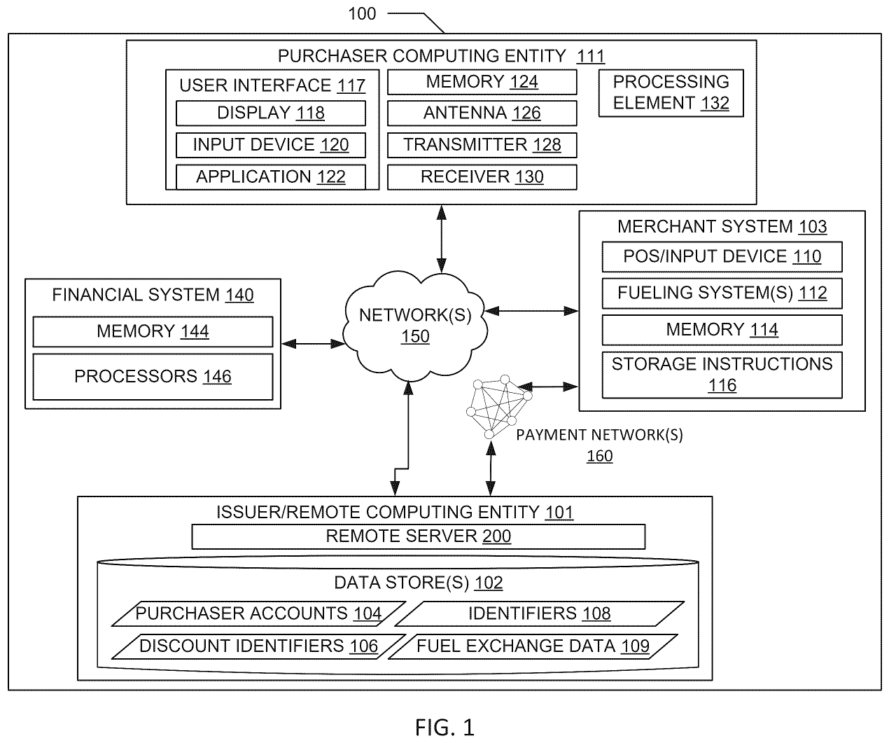

FIG. 1 is an illustration of an exemplary computer-based network environment 100 in which a remote computing entity 101 operates as a multi-channel transaction settlement system for settling purchase transactions. As shown, the remote computing entity 101 is connected with other computing entities through networks 150 and payment networks 160. Thus, the remote computing entity 101 is capable of receiving transaction data through networks 150 (using a closed-loop transaction channel) or payment networks 160 (using an open-loop transaction channel). The remote computing entity 101 may perform different pre-processing or processing steps for transactions, depending on whether network 150 or payment network 160 was used to convey transaction data to the remote computing entity 101. Said differently, remote computing entity 101 may perform different pre-processing or processing steps for transactions, depending on whether the transaction is an open-loop or closed-loop transaction.

The embodiment shown in FIG. 1 is useful for settling fuel purchase transactions, which are characterized by payment challenges that arise in transactions for goods/services of a known value, at least in part because the amount of the purchase is typically not known at the time that a pre-authorization is requested. As shown in FIG. 1, embodiments include a system environment 100 including a remote computing entity 101 (e.g., of an issuer), one or more fuel station systems (as an example of a merchant system 103), one or more purchaser computing entities 111, and one or more financial systems 140. As shown, various of these entities can communicate with one another using networks 150, 160. Network 160 specifically represents a payment/transaction network for processing card-based transactions (e.g., credit card transactions, charge card transactions, debit card transactions, and/or the like). A first transaction channel uses the payment network 160. Network 150 represents a communication network (and fund transfer network) that does not pass through the payment network 160. A second transaction channel uses the network 150. As a specific example, payment network 160 may be managed by VISA®, whereas network 150 may exist separately from the payment network 160 (and may use an Automatic Clearing House (ACH) or other process for transferring funds between an account of the merchant and an account of the issuer). In embodiments discussed herein, the transaction channel using network 150 is a closed-loop transaction channel, whereas the transaction channel using payment network 160 is an open-loop transaction channel. It should be understood that both networks 150, 160 may be operable at least partially via the Internet, but provide different access levels to different entities and have other characteristic differences such that transactions occurring using a second transaction channel that uses one network (e.g., network 150) do not partially or wholly overlap with the first transaction channel that uses the other network (e.g., network 160). In certain embodiments, the payment network 160 may collect a fee for transactions using it, while transactions using network 150 (and therefore passing outside of payment network 160) are not subject to the fee imposed by the payment network 160.

Although not shown, a first Application Program Interface (API) enables communication between the merchant systems 103 and the payment network 160. A second API enables communication between the merchant systems 103 and network 150. A third API enables communication between the remote computing entity 101 and the payment network 160. A fourth API enables communication between the remote computing entity 101 and the network 150. A fifth API enables communication between the financial systems 140 and the payment network 160. A sixth API enables communication between the financial systems 140 and the network 150. A seventh API enables communication between the purchaser computing entity 111 and the network 150. The use of these and/or other APIs (or a subset thereof) is merely an example—other mechanisms enabling communication with and across networks 150, 160 between the illustrated entities and other entities may be usable in certain embodiments.

In various embodiments, the remote computing entity 101 (e.g., of a card issuer and/or a third party sponsoring the card) includes one or more remote servers 200 configured to perform various functions and operations to pre-authorize, authorize, and/or settle purchase transactions such as fuel purchase transactions. The elements of the remote computing entity 101 may be provided via a plurality of computing devices that may be arranged, for example, in one or more server banks or computer banks or other arrangements. Such computing devices can be located in a single installation or may be distributed among many different geographical locations. For example, the remote computing entity 101 can include a plurality of computing devices that together may include a hosted computing resource, a grid computing resource, and/or any other distributed computing arrangement. In some cases, the remote computing entity 101 can correspond to an elastic computing resource where the allotted capacity of processing, network, storage, or other computing-related resources may vary over time.

In various embodiments, the remote computing entity 101 includes one or more data stores 102 configured to store various data that is accessible to the remote server 200 and/or the purchaser computing entity 111, and is used by the system environment 100 to execute various processes and functions discussed herein. The data store 102 can be representative of a plurality of data stores 102 as can be appreciated. The data store 102 can store data such as, but not limited to, purchaser accounts 104, discount identifiers 106, identifiers 108, and ledger data 109. In some embodiments, purchaser accounts 104 together with corresponding discount indicators 106 providing a value of a discount for one or more transactions, identifiers 108, and fuel exchange data (or subsets thereof) are stored in a memory of the purchaser computing entity 111.

In some embodiments, each purchaser account 104 is associated with a purchaser identifier data 501 and identifies a different purchaser and/or corresponding purchaser computing entity 111. The purchaser accounts 104 further comprise computing entity data 503 that associates a particular purchaser computing entity 111 with the purchaser account 104. The purchaser account 104 may additionally comprise credit information data 505 that provides an indication of an amount of credit available to the purchaser (if relevant). In some embodiments, the credit information data 505 may be modifiable by an administrator (that has access to the purchaser account 104 based on the inclusion of administrator data 506 within the purchaser account). The administrator may update/set credit information data 505 such as credit limits, limits on types of purchases, limits on the location of purchases, limits on the time of purchases, and/or the like. The credit information data 505 may, in some embodiments, comprise data identifying a credit account (or a financial institution managing the credit account) associated with the purchaser account 104. The credit account may be associated with an account by which the financial institution or issuer offers credit to the purchaser for purchases, and the purchaser reimburses the financial institution/issuer after the transactions are completed (e.g., on a periodic basis, such as monthly). In other embodiments, a purchaser financial account storing available funds of the purchaser, may be associated with the purchaser account. A purchaser financial account may not be used to complete transactions having a value greater than the amount of funds within the purchaser financial account. In other embodiments, a financial institution managing the purchaser financial account (or an issue) may provide credit for transactions having a value exceeding the amount of funding within the purchaser financial account. In some embodiments, for transactions exceeding a value of funds stored in the purchaser financial account, the issuer or financial institution may request additional funding to be added to the purchaser financial account prior to authorizing the transaction.

In some embodiments, the purchaser accounts include token/discount data 508 that are associated with the purchaser accounts 104 and identify single-use tokens for future or prior purchases. As discussed in greater detail herein, discount data may be purchaser specific, in which case the discount data 508 is stored or referenced within the purchaser account 104. In some embodiments, discounts are merchant specific, in which case relevant discount data may be reflected in a merchant account, or within a listing of discount identifiers 106.

In some embodiments, the purchaser account 104 includes purchaser credentials for verifying an identity of a purchaser or purchaser computing entity 111. Non-limiting examples of purchaser credentials include an identifier, such as username, password, biometric information (e.g., facial image, fingerprint scan, voice signature, and/or the like), cryptographic keys (e.g., public-private key pairs), legal name, age, birth date, internet protocol (IP) address, media access control (MAC) address, international mobile equipment identifier (IMEI) number, and/or the like. The purchaser account 104 may include other data associated with a purchaser, such as a payment card number (as a payment instrument identifier of payment instrument 625) and/or cryptographic keys for deciphering cryptographic tokens that are used in place of payment card numbers during transactions, home address, driver's license number, commercial driver's license (CDL) number, employment status (e.g., independent contractor, self-employed, employee of a particular business, etc.), and/or contact information (e.g., phone number, email address, mailing address, social media accounts, and/or the like). The payment card number and/or cryptographic keys used to decipher cryptographic tokens may be used to identify a payment network 160 used for executing all or part of transactions using the payment card. It should be understood that purchaser accounts may store multiple payment instruments for the purchaser, including payment instruments that use different payment networks for transactions. The purchaser account additionally stores information reflecting a financial institution and/or purchaser financial account at a financial institution that is associated with the purchaser and/or the purchaser's payment instrument. In some embodiments, the purchaser account 104 may store credit information of the purchaser (e.g., credit information identifying a credit account of the purchaser). The credit information comprises an indication of a credit limit for the purchaser (or a specific payment account associated with the purchaser), an indication of the amount of credit used by the purchaser (or a specific credit account associated with the purchaser), an indication of daily (or other period) credit limits, and/or the like. In some embodiments, the credit information may be set at least in part by an administrative user having access to credit settings for the purchaser account 104. For example, the credit information may be set to have an administrator-provided credit limit, an administrator-provided limit on the location(s) where a card may be used by the purchaser, product type(s) that may be purchased by the purchaser with the payment instrument 625, and/or the like. Portions of the credit information may be used during certain steps of processing a transaction, such as checking whether the purchaser's payment card (and associated account) has a sufficient credit limit to settle a transaction.

In some embodiments, the purchaser account 104 stores data received from a financial system 140 that reflects current value of funds within a purchaser financial account. For example, purchaser financial accounts in some embodiments may be partially managed by the issuer/remote computing entity 101, and the financial system 140 may continuously or periodically update the issuer/remote computing entity 101 on the amount of funds currently available within purchaser financial accounts associated with each purchaser account. In some embodiments, the issuer/remote computing entity 101 is configured to provide instructions to the financial system 140 (or an external system) to add additional funding to a purchaser financial account. As a specific example, a purchaser may use computer program application executing on a purchaser computing entity 111 to provide instructions to the issuer/remote computing entity 101 to increase funding within a purchaser financial account associated with the purchaser account.

The purchaser account 104 additionally stores data indicative of one-time use tokens (which also reflects limited use tokens, in certain embodiments) that are generated for use in place of payment instruments 625. These one-time use tokens are utilized for initiating closed-loop transactions, and they are generated by the remote computing entity 101 for a particular purchaser/purchaser account 104. The one-time use tokens are stored in a purchaser account together with usage data, such as limitations on use (e.g., defining a single merchant that accepts the one-time use token, defining an expiration date/time for the one-time use token, and/or the like). In some embodiments, the one-time use tokens define a product price or a discount to be used for the transaction (e.g., for one-time use tokens used for purchasing fuel, the one-time use token may be stored with a unit price for fuel purchases. This unit price may differ from a publicly accessible, published unit price for the fuel). In some embodiments, a one-time use token may be stored together with product price and/or discounts for a plurality of products—each product may be subject to different discount amounts or different unit pricing. The one-time use token may then be used for purchasing any or all of the plurality of products for which a discount or price is provided and stored together with the one-time use token.

In some embodiments, the purchaser account 104 includes data associated with one or more vehicles owned or operated by a purchaser, such as a vehicle registration number, license plate number, vehicle manufacturer, vehicle model, vehicle manufacture year, vehicle service record, vehicle emissions record, and/or the like. In some embodiments, the purchaser account 104 includes data associated with historical fuel events. For example, the purchaser account 104 may include historical transaction data, fuel exchange amounts, historical fueling locations, historical fuel volumes, and/or the like. In some embodiments, the purchaser account 104, or a subset thereof, is stored in an encrypted format. For example, personally identifiable information (PII) associated with a purchaser, or an associated vehicle, may be encrypted such that access thereto requires a dual-authentication process, authentication of a public-private key pair, and/or other security measure.

In some embodiments, discount identifiers 106 are stored within a look-up table that can be used by the remote computing entity 101 to determine an appropriate discount to be applied to a particular transaction. As mentioned, discounts may be transaction specific and may be associated with a one-time use token 517 or other unique discount identifier (e.g., a single-use token that is limited to use by a single purchaser, at a single merchant, for a limited period of time). In those embodiments, the one-time use tokens may be stored in a purchaser account 104 (as discussed above) and/or may be cross-referenced within a table of discount identifiers 106. In other embodiments, discounts may be merchant specific 513 and may be associated with discount identifiers 106 that are usable for any transaction with the merchant (these discount identifiers 106 may be stored in a merchant account or may reference the merchant account), purchaser specific 515 and may be associated with discount identifiers 106 that are usable for any transaction with the purchaser (these discount identifiers 106 may be stored in a purchaser account or may reference the purchaser account), and/or the like. In any embodiment, discount identifiers 106, along with discount data defining qualifications for using a particular discount, is stored in data store 102 in a look-up table enabling the remote computing entity 101 to determine an appropriate discount for a transaction, based on transaction data received through the payment network 160. The transaction data may be matched with portions of the discount data of a particular discount identifier 106 to identify the appropriate discount for application during a particular transaction. The type and/or amount of discount (e.g., percentage off, including the defined percentage, gross discount, including the defined gross discount amount, and/or the like) is stored as a part of the discount data, thereby enabling the remote computing entity 101 to apply the discount to a transaction. For example, the received transaction data includes a payment instrument identifier (e.g., a an encrypted payment instrument identifier or cryptographic token representing the payment instrument identifier, or other identifying data that may be used to identify a payment instrument and/or purchaser account associated with the payment instrument), a one-time use token, a merchant identifier, a transaction identifier, and/or the like. Portions of the transaction data may be compared against the look-up table including the discount data to identify an appropriate discount to apply against the transaction. Where multiple matching discount identifiers are located within the look-up table, the remote computing entity 101 applies a stored criterion to identify the discount for use in the transaction (e.g., lowest overall price, lowest unit price, most-recent discount, and/or the like). The look-up table is dynamically updated in some embodiments (e.g., as discount identifiers 106 and associated discounts are generated, used, or expired, for example). Discounts may be provided as a percentage, a gross amount, or the like.

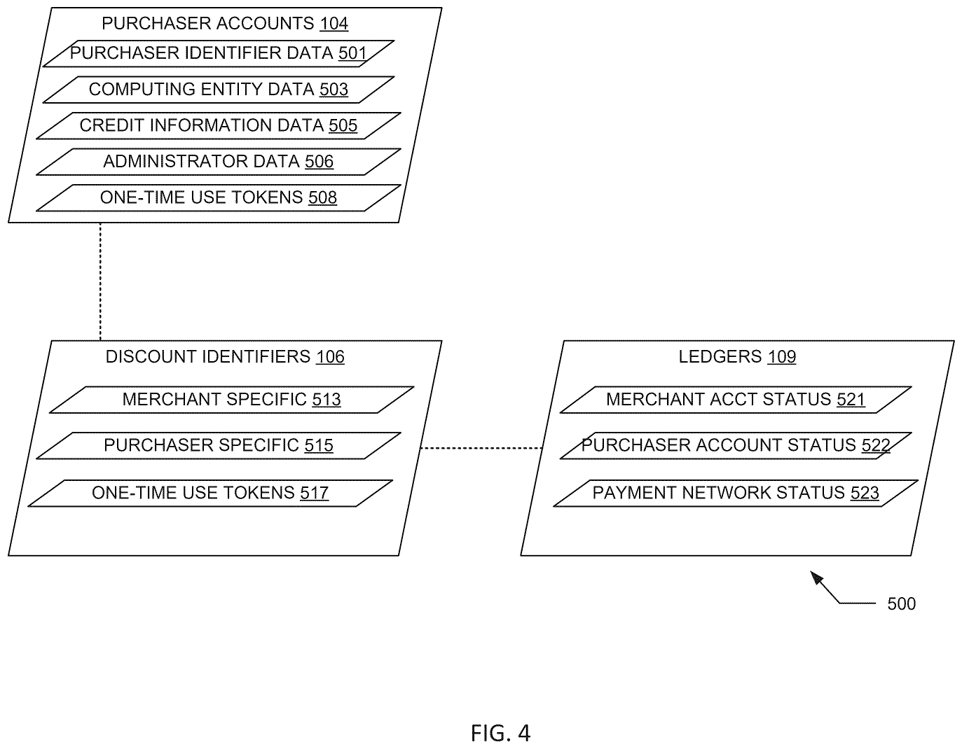

In some embodiments, the data store 102 stores one or more ledgers in ledger data 109, as shown in FIG. 4. The one or more ledgers may comprise a merchant account status ledger 521. As discussed in greater detail below, the merchant account status ledger may comprise data identifying transactions completed, data identifying payments received, and/or data identifying costs owed and/or paid as a part of transactions. The one or more ledgers may additionally comprise purchaser account status ledgers 522. The purchaser account status ledgers 522 may comprise data identifying an amount of credit extended to a purchaser, an amount of credit available to the purchaser, and/or the like. In some embodiments, the purchaser account status ledgers 522 comprise historical data, such as historical transaction data for the purchaser. For example, the purchaser account status ledger 522 may comprise an indication of previous purchases (e.g., historical fuel events). The data may comprise item-level data (e.g., identifying the goods/services purchased) or transaction level data (e.g., identifying the total transaction value). The data may identify the merchant, the location of the transaction, the time/date of the transaction, and/or the like.

In some embodiments, the ledger data comprises a payment network status ledger 523. The payment network status ledger 523 may comprise data identifying transactions completed using the payment network 160. In certain embodiments, the payment network status ledger 523 provides an audit trail of transactions completed in part using a first transaction channel of the payment network 160. For example, the payment network status ledger 523 comprises data identifying a merchant and a purchaser involved in a transaction, a payment instrument used for the transaction (or an encrypted indication of the payment instrument used), a time and date of the transaction, the first transaction value of the transaction, an amount of fees collected by the payment network 160, an amount of funds paid by the payment network 160 to the issuer, and/or the like.

In some embodiments, the merchant system 103 includes a combination of hardware and software configured to initiate an exchange of value for fuel (e.g., diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, and/or the like). For example, the merchant system 103 may include a point-of-sale (POS) terminal having input device(s) that are collectively configured to initiate transactions, specifically to initiate fuel exchanges and exchanges of value for the fuel exchanges. Additionally, in some embodiments, the merchant system is configured to initiate transactions, such as an exchange of value for additional fuel- or vehicle-related goods and services, such as fuel additives, motor oil, windshield washer fluid, anti-freeze solution, vehicle components, vehicle maintenance, weighing services, and/or the like.

In some embodiments, the merchant system 103 includes a point-of-sale (POS) system that comprises one or more input devices 110 configured to receive user inputs. The input devices 110 include a keypad (hard or soft), a touch display, voice/speech or motion interfaces, or other input device. In embodiments including a keypad, the keypad can include (or cause display of) the conventional numeric (0-9) and related keys (#, *), and other keys used for operating the merchant system 103 and may include a full set of alphabetic keys or set of keys that may be activated to provide a full set of alphanumeric keys. In some embodiments, the input device 110 includes a fuel exchange software interface rendered on a display of the merchant system 103 or on a computing device in configured to communicate with the merchant system 103 via wired or wireless communication, such as via a network 150.

In some embodiments, the merchant system 103 includes or is configured to communicate with and control one or more fueling systems 112. In some embodiments, the fueling system 112 is a system configured to control access to fuel. For example, the fueling system 112 may be a device, such as a fuel pump, that dispenses fuel to a purchaser, a vehicle, and/or a fuel container. In one example, the fueling system 112 may be device that enables and disables a fuel pump handle that controls access to fuel from a fuel pump reservoir. In another example, the fueling system 112 may be a device, such as an adjustable valve, that enables and disables access to a fuel pump reservoir. In another example, the fueling system 112 may include a locking mechanism that enables and disables access to a fuel storage receptacle and/or retrieval of a fuel container. In another example, the fueling system 112 may be a system that reserves or saves an allotment of fuel for collection by a purchaser, such as for a wholesale fuel exchange between a fuel supplier and fuel vendor.

In some embodiments, the fueling system 112 is configurable between an inactive state and an active state. In some embodiments, when configured to the inactive state, the fueling system 112 is incapable of or prevents a purchaser from dispensing fuel, or otherwise providing access to fuel. In one example, the fueling system 112 is a fuel pump and, in the inactive state, the fuel pump is rendered inoperable for dispensing fuel. In another example, the fueling system 112 is a storage receptacle comprising a locking mechanism and, in the inactive state, the locking mechanism is enabled to prevent opening of the storage receptacle and/or extraction of a fuel container from the storage receptacle. In some embodiments, when configured to the active state, the fueling system 112 allows a purchaser to dispense fuel or retrieve fuel from a storage receptacle. For example, the fueling system 112 is a fuel pump and, in the active state, the fuel pump is operable for dispensing fuel. In another example, the fueling system 112 is a storage receptacle comprising a locking mechanism and, in the active state, the locking mechanism is disabled to permit opening of the storage receptacle and/or retrieval of a fuel container from the storage receptacle.

In some embodiments, the merchant system 103 (or a computing device of the merchant system 103) stores and runs executable computer instructions (e.g., point-of sale (POS) software, fueling system control program, and/or the like). In some embodiments, by executing the computer instructions, the merchant system controls activation and deactivation of a fueling system 112 by transitioning the fueling system 112 between an inactive state and an active state. In one example, the computer instructions include POS software that, when run by the merchant system 103, allow the merchant system 103 to activate and deactivate one or more fuel pumps at a fueling location based on a fuel exchange. In some embodiments, the computer instructions, when executed, enable the merchant system 103 to transition the fueling system 112 between inactive and active states based on one or more aspects of a fuel exchange. In some embodiments, the computer instructions, when executed, enable the merchant system 103 to generate and render graphical user interfaces on a display provided to an operator of a fueling station. In various embodiments, the graphical user interfaces facilitate receipt of particular types of input data for authorizing a fuel exchange.

The merchant system 103 is configured to generate transaction data, such as an indication of the products or services purchased (e.g., a stock keeping unit (SKU) or other indicator), a quantity of the product or services purchased, and/or the like. As another example, the transaction data may comprise an indication of a type of fuel being provided to the purchaser, such as diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, fuel octane level, and/or the like. In still another example, the transaction data may include identifying information for a fueling system 112 (e.g., a fuel pump number and/or the like) by which fuel is provided to the purchaser. In another example, the transaction data may include a current volume of fuel provided during an in-progress fuel exchange, maximum fuel volume for the fuel exchange, total fuel volume provided for a completed fuel exchange, and/or the like. In some embodiments, the merchant system 103 updates and stores the transaction data in substantially real-time such that the transaction data may be accessed and/or transmitted by the networks 150, 160.

In some embodiments, the merchant system 103 is associated with a merchant account stored at the remote computing entity 101. The merchant account comprises an identifier for identifying the merchant system 103 and comprises merchant-specific data. The merchant-specific data may comprise data such as a geolocation of the merchant, a name of the merchant, photos of the merchant, identifiers of fuel dispensers (e.g., fuel pumps) at the merchant, identifiers of services provided by the merchant (e.g., showers, fuel-types, restaurant, and/or the like). Certain of this merchant data may be provided to purchaser computing entities 111 that are connected with the remote computing entity 101.

The merchant-specific data additionally comprises merchant-specific payment data for passing payments to and from the merchant (e.g., using ACH or another payment method constituting the second payment channel). This information is not provided to purchaser computing entities 111. The merchant-specific payment data may comprise merchant financial account data (e.g., at a financial institution), electronic wallet information, and/or the like. This payment account information may be usable by the remote computing entity 101 to initiate payments to and/or from the merchant's financial account using a second payment channel that uses network 150 and is separate from the payment network 160. In some embodiments, the merchant account comprises historical transaction data for the merchant, including a ledger of transactions occurring at the merchant (with various purchasers) that utilized the remote computing entity 101 for settlement of at least a part of the transaction. The ledger may distinguish between transactions using the closed-loop transaction channel and the open-loop transaction channel.

As discussed above, certain discount identifiers 106 may be merchant-specific discounts, and these discount identifiers 106 may be generated based on data updated and/or otherwise stored within a merchant account. For example, a merchant may update data stored within the merchant account to define the qualifications for discounts and/or to define the type and/or amount of discount. As an example, a merchant may store data indicating that fuel is to be discounted 2% off of a published price for purchasers having accounts with the remote computing entity 101. In certain embodiments, discounts may be both purchaser and merchant specific (e.g., tied to a fuel code that is only usable by a single purchaser at a single merchant). The merchant account may store data reflecting active discounts that are merchant and purchaser specific. These may be unredeemed and unexpired discounts, along with associated data identifying purchasers for which the discounts apply, and data identifying the amount of each discount. In some embodiments, the merchant account additionally stores data of redeemed and/or expired discounts that are purchaser and merchant specific.

Moreover, the merchant account defines APIs or other connections enabling the remote computing entity 101 to receive or retrieve data identifying published prices of goods/services for which various discounts may apply. For example, the merchant account may comprise an API enabling the remote computing entity 101 to obtain fuel pricing published by the merchant. The published prices of goods/services may be stored within the merchant account and may be updated in real-time or periodically.

### Exemplary Purchaser Computing Entity

A purchaser may interact with a purchaser computing entity 111 via a user interface thereon, and/or the purchaser may interact with a purchaser computing entity 111 to obtain information/data regarding a purchaser account 104, one or more discount identifiers 106 (and/or one-time use tokens), one or more identifiers 108, fuel exchange data, and/or an instrument of exchange associated with a purchaser. As will be recognized, an instrument of exchange associated with a purchaser, purchaser account 104, and/or purchaser computing entity 111 may be any of a number of different instrument types, including a credit instrument, debit instrument, cryptographic asset wallet, bank-administrated financial account (e.g., associated with a purchaser financial account), non-bank-administered financial account, and/or the like.

A payment instrument 625 may include a credit card associated with a credit account administered by a financial institution or other credit-providing entity using a payment network 160 that can provide payments on behalf of a purchaser, and to which the purchaser is obligated to reimburse for such payments. A debit instrument may include a debit card associated with a purchaser's checking account, savings account, or other deposit account and by which payments may be made on behalf of the purchaser via transfer of assets out of the corresponding deposit account using the debit instrument to verify the transfer. A bank-administered financial account may include a bank-administered checking account, savings account, money market account (MMA), certificate of deposit account (CD), and/or the like, that holds financial assets of a purchaser and by which payments may be made on behalf of the purchaser via electronic funds transfer (EFT), such as via an automated clearing house (ACH). The financial system 140 may be a computing system of a bank (or other financial institution) that manages accounts for the issuer and purchaser (and in some instances, the merchant). As shown the financial system 140 includes memory 144 and processors 146 that collectively enable the financial system to manage and maintain financial accounts for various entities. A non-bank-administered financial account may be a financial account associated with a non-banking entity that holds financial assets on behalf of a purchaser and by which payments may be made on behalf of the purchaser via transfer of the financial assets via a payment platform. Non-limiting examples of a non-bank-administered financial account include digital wallets (e.g., PayPal, Venmo, Zelle, and/or the like), accounts on stock or commodity trading platforms, accounts on person-to-person or business-to-business lending platforms, and/or the like. A cryptographic asset wallet may include a device, physical medium, program, or service that stores public and/or private keys for authorizing transfers of cryptographic assets (e.g., Bitcoin, Ethereum, Tether, and/or the like) via a distributed ledger service, such as a blockchain protocol or smart contract (e.g., Bitcoin protocol, Ethereum network, TRON network, etc.).

In some embodiments, the purchaser computing entity 111 and financial system 140 includes one or more components that are functionally similar to those of the remote server 200. As noted previously, the terms device, system, computing entity, entity, server, and/or similar words used herein interchangeably may refer to at least, for example, one or more computers, computing entities, mobile phones, tablets, phablets, watches, glasses, car pieces, wristbands, wearable items/devices, fobs, other internet-of-things (IoT) devices, and/or the like, and/or any combination of devices or entities adapted to perform the functions, operations, and/or processes described herein. In some embodiments, the purchaser computing entity 111 includes one or more displays 118, one or more input devices 120, an application 122, and memory 124. In some embodiments, the purchaser computing entity 111 includes an antenna 126, a transmitter 128 (e.g., radio), a receiver 130 (e.g., radio), and a processing clement 132 (e.g., CPLDs, microprocessors, multi-core processors, cloud processors, coprocessing entities, ASIPs, microcontrollers, and/or controllers) that provides signals to and receives signals from the transmitter 128 and receiver 130, respectively.

In one embodiment, the signals provided to and received from the transmitter 128 and the receiver 130, respectively, may include signaling information/data in accordance with air interface standards of applicable wireless systems. In this regard, the purchaser computing entity 111 may be capable of operating with one or more air interface standards, communication protocols, modulation types, and access types. More particularly, the purchaser computing entity 111 may operate in accordance with any of a number of wireless communication standards and protocols, such as those described above with regard to the remote server 200 or merchant system 103. In a particular embodiment, the purchaser computing entity 111 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the purchaser computing entity 111 may operate in accordance with multiple wired communication standards and protocols, such as those described above with regard to the remote server 200 via a network 150.

Via these communication standards and protocols, the purchaser computing entity 111 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). In one embodiment, the purchaser computing entity 111 can also download changes, add-ons, and updates, for instance, to its firmware, software (e.g., including executable instructions, applications, program modules), and operating system.

According to one embodiment, the purchaser computing entity 111 may include location determining aspects, devices, modules, functionalities, and/or similar words used herein interchangeably. For example, the purchaser computing entity 111 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). In one embodiment, the satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the purchaser computing entity 111 in connection with a variety of other systems, including cellular towers, Wi-Fi access points, and/or the like. Similarly, the purchaser computing entity 111 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Bluetooth Smart, Wi-Fi Direct transmitters, NFC transmitters, and/or the like. These indoor positioning aspects can be used in a variety of settings to determine the location of someone or something to within inches or centimeters.

In some embodiments, the purchaser computing entity 111 includes an application 122 that accesses services and functions of the remote computing entity 101. For example, the purchaser computing entity 111 may communicate with the remote computing entity 101 using the application 122. In some embodiments, the remote computing entity 101 provides information about merchants that provide discounts to purchasers via the issuer/remote computing entity 101, using the application 122. In some embodiments, the remote computing entity 101 provides a map graphical user interface within application 122 to guide purchasers to certain merchants. In some embodiments, the application 122 transmits request for generation and receipt of discount identifiers 106 (e.g., one-time use tokens) to the remote computing entity 101. For example, the application 122 causes the purchaser computing entity 111 to generate a graphical user interface by which a purchaser may provide a user input for requesting generation and receipt of a one-time use token for a fueling location associated with a fuel entity. In response to the purchaser computing entity 111 receiving the user input, the application 122 may generate and transmit to the remote computing entity 101 a one-time use token request including the fueling location, an identifier for the fuel entity, a timestamp of the user input, a location of the purchaser computing entity 111, and/or the like. In some embodiments, the application 122 receives a one-time use token from the remote computing entity 101 and stores the one-time use token in memory 124 of the purchaser computing entity 111. In some embodiments, the application 122 causes the purchaser computing entity 111 to generate and render graphical user interfaces for requesting a one-time use token, displaying a location of the purchaser computing entity 111, displaying a location of one or more fueling locations, displaying a fuel exchange ratio for one or more fueling locations, accessing and displaying information associated with a purchaser account 104, accessing and displaying historical fuel exchange data, and/or the like.

In one example, the application 122 communicates with the remote computing entity 101 to receive geolocation data indicative of a location of one or more fueling locations. The application 122 may cause the purchaser computing entity 111 to generate and render a graphical user interface including a map on which the locations of the one or more fueling locations are rendered.

In some embodiments, the application 122 interfaces with other software or applications installed or running on the purchaser computing entity 111. Such software may include geolocation software, Internet browsing software, image capture software, user authentication software, and software that manages or provides access to information associated with a purchaser's payment instruments (e.g., credit cards, debit cards, banking accounts, cryptographic asset wallets, and other payment instruments). In one example, the application 122 interfaces with a navigation application to determine and provide a location of the purchaser computing entity 111 to the remote computing entity 101 and/or generate a graphical user interface including a virtual map that displays the location and one or more fueling locations. In another example, the application 122 interfaces with a payment instrument management application to obtain and provide to the remote computing entity 101 various data associated with the purchaser's payment instrument (e.g., credit card number, expiration data, card verification value, and/or the like).

In one embodiment, the purchaser computing entity 111 may also comprise a user interface 117 (that can include a display 118 coupled to a processing element 132), which may include user input interface (coupled to a processing element 132 (e.g., which may be embodied as one or more processors)). For example, the user interface 117 may be an application 122, browser, user interface, interface, and/or similar words used herein interchangeably executing on and/or accessible via the purchaser computing entity 111 to interact with and/or cause display of information/data from the remote server 200, as described herein. The user input interface can comprise any of input devices 120 allowing the purchaser computing entity 111 to receive data, such as a keypad (hard or soft), a touch display, voice/speech or motion interfaces, or other input device. In embodiments including a keypad, the keypad can include (or cause display of) the conventional numeric (0-9) and related keys (#, *), and other keys used for operating the purchaser computing entity 111 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

In certain embodiments, the user interface (e.g., the display 118) may be configured for displaying one-time use tokens that may be provided or presented to a merchant system 103 to initiate and enable authorization of a fuel exchange. For example, the user interface of the purchaser computing entity 111 may be utilized to display a QR code, a bar code, an image, and/or the like that is machine-readable and indicative of a one-time use tokens. Similarly, the purchaser computing entity 111 may be configured for storing one-time use tokens thereon, and transmitting inputs indicative of one-time use tokens via any of a variety of wireless data transmission protocols (e.g., Bluetooth, Wi-Fi, NFC, and/or the like) to the merchant system 103.

In some embodiments, the purchaser computing entity 111 includes memory 124, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The memory 124 may include volatile memory and/or non-volatile memory. The memory 124 can store databases, database instances, database management systems, data, applications, programs, program modules, scripts, source code, object code, byte code, compiled code, interpreted code, machine code, executable instructions, and/or the like to implement the functions of the purchaser computing entity 111. The memory 124 can store one-time use tokens, data associated with a purchaser account 104, identifiers 108, and/or fuel exchange data. As indicated, this may include an application 122 that is resident on the purchaser computing entity 111 or accessible through a browser or other user interface for communicating with the remote server 200, merchant system 103, and/or various other computing entities.

As will be recognized, the purchaser computing entity 111 may include one or more components or functionality that are the same or similar to those of the remote server 200, as described in greater detail below. As will be recognized, these architectures and descriptions are provided for exemplary purposes only and are not limiting to the various embodiments.

### Exemplary Networks

In one embodiment, any two or more of the illustrative components of the architecture of FIG. 1 may be configured to communicate with one another via respective communicative couplings to one or more networks 150, 160. The networks 150, 160 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 150, 160 may have any suitable communication range associated therewith and may include, for example, global networks (e.g., the Internet), metropolitan area networks (MANs), wide area networks (WANs), local area networks (LANs), or personal area networks. In addition, the networks 150 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Transmissions over networks 150, 160 may be “in the clear” or may leverage one of more of a variety of industry-standard or third-party security technologies implemented in any of the OSI layers used. If encryption is used, it may be symmetric or asymmetric (or implement a combination of the two, as in SSL/TLS, where the initial handshake uses asymmetric encryption in the exchange of symmetric keys, and subsequent transactions use symmetric encryption based on the previously exchanged symmetric keys). As will be recognized, process interaction over a network may be synchronous or asynchronous: synchronous—processes are coupled and include web services (e.g., SOAP), which may in turn leverage http(s); and various other remote procedure call (RPC), middleware protocols, industry-standard exchange formats (e.g., XML or JSON), and integration architectures (e.g., REST) and/or asynchronous—processes are decoupled and mechanisms include message queues and file transfers.

As discussed throughout this disclosure, networks 150, 160 may provide distinct functionalities from one another, and/or may be characterized by different entity access capabilities. For example, data transmissions (and payments) made using network 150 may be encrypted and inaccessible to a manager of a payment network 160. As a specific example, a payment made using network 150 may not be visible to VISA® or other payment networks 160, and therefore the payment made using a second payment channel of network 150 does not use any of the feature or functionality of payment networks 160. By contrast, a payment made using a first payment channel of payment network 160 is visible to the payment network 160 (e.g., VISA® for certain payment networks), so that the payment network ensures the payment remains secure, and so that the payment network can deduct a percentage of the first transaction value (calculated based on the published/publicly advertised price of goods/services) as reimbursement for the services provided from the payment network 160.

In both instances, data and payments transferred using networks 150 and 160 may be encrypted and/or otherwise secure against unauthorized third parties attempting to intercept the payment or information identifying the payment.

### Exemplary Remote Server

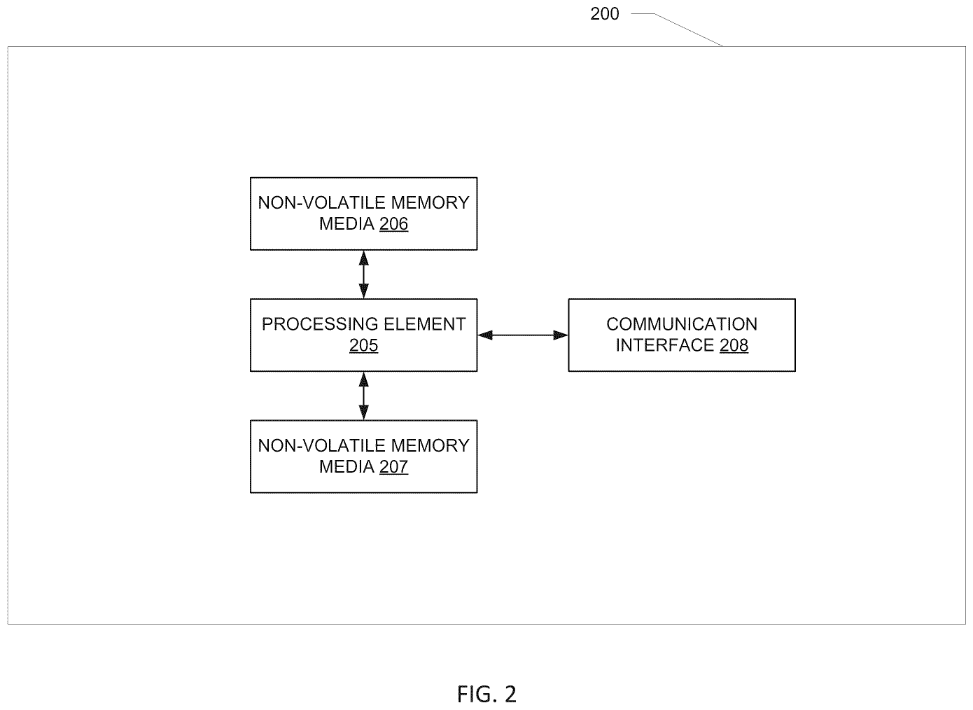

FIG. 2 provides a schematic of a remote server 200 of a remote computing entity according to one embodiment. In one embodiment, the remote server 200 may be in network communication with one or more purchaser computing entities 111, one or more computing systems associated with administrating and/or issuing an instrument of exchange, and/or the like. In certain embodiments, the remote server 200 may be operable in association with other computing devices and/or platforms (e.g., operable via third parties, such as banking institutions' online banking platforms) to accomplish certain functions (e.g., user authentication) to retrieve certain data, and/or the like. In general, the terms computing entity, computer, entity, device, system, server, machine, and/or similar words used herein interchangeably may refer to, for example, one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In one embodiment, the remote server 200 may include or be in communication with one or more one or more processing elements 205 (also referred to as processors, processing circuitry, processing device, and/or similar terms used herein interchangeably) that communicate with other elements within the remote server 200 via a bus, for example. In certain embodiments, the processing clement may access various data to perform functions of the remote server 200, such as purchaser accounts (e.g., user (login) ID, password (or other authentication credential(s), user name, user registration status, and/or the like), one-time use tokens, identifiers, fuel exchange data, and/or the like. As will be understood, the processing element 205 may be embodied in a number of different ways. For example, the processing element 205 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile memory or otherwise accessible to the processing element 205. As such, whether configured by hardware or computer program products, or by a combination thereof, the processing element 205 may be capable of performing steps or operations according to embodiments of the present techniques for fuel exchange authorization and optimization when configured accordingly.

In one embodiment, the remote server 200 may further include or be in communication with non-volatile memory 206 (also referred to as non-volatile storage, memory, memory storage, memory circuitry and/or similar terms used herein interchangeably), which may include or be embodied as one or more data stores 102. In one embodiment, the non-volatile storage or memory may include one or more non-volatile storage or memory media 206, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 206 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In one embodiment, the remote server 200 may further include or be in communication with volatile memory 207 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the remote server 200 with the assistance of the processing element 205 and operating system.

As indicated, in one embodiment, the remote server 200 may also include one or more communications elements/interfaces 208 for communicating with various computing entities, such as by communicating data, content, information, and/or similar terms used herein interchangeably that can be transmitted, received, operated on, processed, displayed, stored, and/or the like. For instance, the remote server 200 may communicate with one or more networks 150, one or more purchaser computing entities 111, one or more merchant systems 103, one or more computing systems associated with administration or issuance of an instrument of an exchange (e.g., banking institutions, credit and/or debit card networks, cryptographic asset environments, such as blockchains, etc.,), and/or the like.

In certain embodiments, the remote server 200 may be configured to authorize fuel exchanges based at least in part on receipt and processing of data as described herein. The remote server 200 may receive a fuel exchange payload as a part of transaction data generated by the merchant system respective to a fuel event, where the fuel exchange payload indicates a fuel exchange amount. The remote server 200 may authorize and initiate an exchange of value for the fuel exchange amount using a purchaser's instrument of exchange or based at least in part on a one-time use token provided as a part of the transaction data. Thus, the remote server may enable authorization and initiation of fuel exchanges without exposing sensitive information for the instrument of exchange to the merchant system (e.g., also eliminating a need for a purchaser to present such information to an operator of the merchant system).

As indicated, in one embodiment, the remote server 200 may also include one or more communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the remote server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The remote server 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Although not shown, the remote server 200 may include or be in communication with one or more input elements, such as a keyboard input, a mouse input, a touch screen/display input, motion input, movement input, audio input, pointing device input, joystick input, keypad input, and/or the like. In one embodiment, the remote server 200 may also include or be in communication with one or more output elements (not shown), such as audio output, video output, screen/display output, motion output, movement output, and/or the like.

As will be appreciated, one or more of the components of the remote server 200 may be located remotely from other remote server 200 components, such as in a distributed system. Furthermore, one or more of the components may be combined and additional components performing functions described herein may be included in the remote server 200. Thus, the remote server 200 can be adapted to accommodate a variety of needs and circumstances. As will be recognized, these architectures and descriptions are provided for exemplary purposes only and are not limiting to the various embodiments.

### Exemplary Merchant System

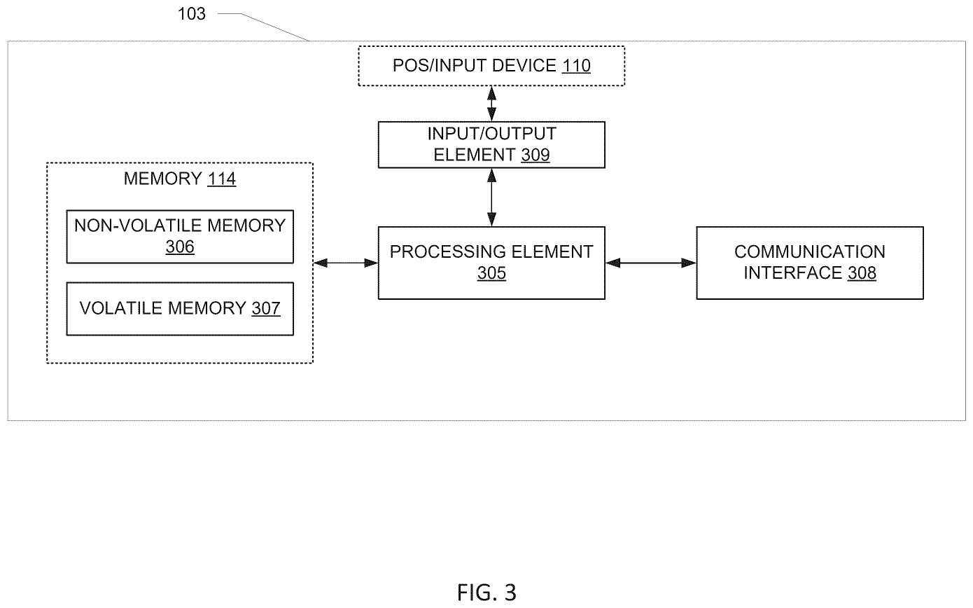

FIG. 3 provides a schematic of a merchant system 103 according to one embodiment. In one embodiment, the merchant system 103 may be in network communication with one or more purchaser computing entities 111, one or more remote computing entities 101, computing systems associated with administrating and/or issuing an instrument of exchange, and/or the like. The merchant system 103 may communicate via network 150 and payment network 160. In certain embodiments, the merchant system 103 may be operable in association with other computing devices and/or platforms (e.g., operable via third parties, such as banking institutions' online banking platforms) to accomplish certain functions (e.g., receiving user input, generating and providing fuel exchange authorization data objects and fuel exchange payloads, etc.) to retrieve or provide certain data, and/or the like.

In various embodiments, the merchant system 103 includes or embodies one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. For example, the merchant system 103 may receive user inputs indicative of fuel codes and other fuel exchange-related data, such as an identifier for a fueling system by which fuel may be provided to a purchaser. As another example, the merchant system 103 may control a fueling system, such as by transitioning a fueling system between inactive and active states, based on data received from a remote computing entity via a fuel exchange processing service and one or more APIs. In another example, the merchant system 103 processes a user input based on a storage instruction and determines that the user input includes a format corresponding to a fuel code payment type. In another example, in response to recognizing a user input as indicative of a fuel code, the merchant system transforms the user input into a data format by which the user input may be transmitted to or collected by a fuel exchange processing service and provided to a remote computing entity using one or more APIs. In one embodiment, these functions, operations, and/or processes can be performed on data, content, information, and/or similar terms used herein interchangeably.

In one embodiment, the merchant system 103 may include or be in communication with one or more processing elements 305 (also referred to as processors, processing circuitry, processing device, and/or similar terms used herein interchangeably) that communicate with other elements within the merchant system 103 via a bus, for example. In certain embodiments, the processing element 305 may access or receive data associated with performing functions described herein, such as user inputs, one-time use tokens, validations or rejections of one-time use tokens, fuel exchange-related data (e.g., fuel volumes, fuel volume limits, fuel types), and/or the like. As will be understood, the processing clement 305 may be embodied in a number of different ways. For example, the processing element 305 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in memory 114 (e.g., in volatile or non-volatile memory) or otherwise accessible to the processing element 305. As such, whether configured by hardware or computer program products, or by a combination thereof, the processing element 305 may be capable of performing steps or operations according to embodiments of the present techniques for fuel exchange authorization and optimization when configured accordingly. In various, functions of the processing element 305, and/or other elements of the merchant system 103, are modified according to storage instructions. Such storage instructions, when executed by the processing element 305, may enable the merchant system 103 to recognize user input for one-time use tokens as a valid identifier for an instrument of exchange. When executed by the processing element 305, the storage instructions may also cause the merchant system 103 to transform such user input, and potentially other fuel exchange-related data, into a format by which the user input may be provided to or collected by an external computing system, such as via one or more APIs.

In one embodiment, the merchant system 103 may further include or be in communication with non-volatile memory 306 (also referred to as non-volatile storage, memory, memory storage, memory circuitry and/or similar terms used herein interchangeably), which may include or be embodied as memory 114. In one embodiment, the non-volatile storage or memory may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like. In some embodiments, the non-volatile memory 306 stores storage instructions 116 that cause the processing element 305 to modify a format of user input data stored at the merchant system 103 to enable performance of functions described herein for remotely initiating and executing fuel exchanges based on user inputs indicative of one-time use tokens.

In one embodiment, the merchant system 103 may further include or be in communication with volatile memory 307 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 307, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the merchant system 103 with the assistance of the processing element 305 and operating system. In some embodiments, the volatile memory 307 temporarily stores user inputs according to a storage instruction 116. For example, in response to the processing element 305 recognizing a user input as indicating a one-time use token (e.g., via execution of the storage instruction 116), the volatile memory 307 temporarily stores the user input according to the storage instruction 116.

As indicated, in one embodiment, the merchant system 103 may also include one or more communications elements/interfaces 308 for communicating with various computing entities, such as by communicating data, content, information, and/or similar terms used herein interchangeably that can be transmitted, received, operated on, processed, displayed, stored, and/or the like. For instance, the merchant system 103 may communicate with one or more networks 150, payment networks 160, one or more purchaser computing entities 111, a remote computing entity 101, one or more fueling systems 112, one or more computing systems associated with administration or issuance of an instrument of an exchange (e.g., banking institutions, credit and/or debit card networks, cryptographic asset environments, such as blockchains, etc.), and/or the like.

In some embodiments, the merchant system 103 includes one or more input/output elements 309 that receive an indication of a user input and, in some embodiments, provide an output or input to one or more computing devices. In some embodiments, the input/output element 309 embodies or communicates with the input device 110 (which may be a part of, or may be embodied as a POS). For example, the input/output clement 309 provides output to and receives input from one or more computing devices (e.g., purchaser computing entities 111, input devices 110, and/or the like). In one example, the input/output element 309 receives a user input indicative of a one-time use token, a fuel type, a fueling system, and/or the like. In some embodiments, the input/output clement 309 provides user inputs to the processing element 305. The input/output element 309 may comprise one or more fuel exchange software interface(s) and in some embodiments includes a display that comprises the interface(s) rendered as a web user interface, an application user interface, a purchaser device, a backend system, or the like. In some embodiments, the input/output element 309 also includes a keyboard, a mouse, a joystick, a touch screen, touch areas, soft keys, a microphone, a speaker, and/or other input/output mechanisms.

In certain embodiments, using the processing clement 305, memory 114, communication interface 308, and input/output element 309, the merchant system 103 may be configured to obtain authorization for fuel exchanges based at least in part on receipt and processing of data as described herein. For example, the merchant system 103 may receive a user input and/or other input indicative of a requested fueling transaction. Transaction data may be passed to the remote computing entity 101 using the payment network 160 or network 150. The merchant system 103 may receive an authorization from the remote computing entity 101 via a relay of the authorization using the payment network 160 or directly from the closed-loop transaction channel. The authorization of the transaction data may cause the merchant system 103 to transition a fueling system from an inactive state to an active state (e.g., potentially based additional fuel exchange data received, such as a fuel volume limit, preauthorization limit, and/or the like). Merchant system 103 may determine a fuel volume and generate a fuel exchange amount based on the fuel volume. The merchant system 103 may generate a transaction data payload indicative of the fuel exchange amount and provide the transaction payload to the remote computing entity 101 using the payment network 160 (e.g., using one or more APIs).

As indicated, in one embodiment, the merchant system 103 may also include one or more communication interfaces 308 for communicating with various computing entities, such as by communicating data, content, information, and/or similar terms used herein interchangeably that can be transmitted, received, operated on, processed, displayed, stored, and/or the like over network 150 and/or payment network 160. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the merchant system 103 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The merchant system 103 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the components of the merchant system 103 may be located remotely from other merchant system 103 components, such as in a distributed system. Furthermore, one or more of the components may be combined and additional components performing functions described herein may be included in the merchant system 103. Thus, the merchant system 103 can be adapted to accommodate a variety of needs and circumstances. As will be recognized, these architectures and descriptions are provided for exemplary purposes only and are not limiting to the various embodiments.

### Technical Challenges

Existing payment systems are limited to processing transactions using a single transaction channel. Most commonly, credit card (or charge card) processing using a payment network associated with the credit/charge card provides the majority of consumers with a pleasing transaction experience. However, the use of a payment network has relatively high fees for merchants, and provides merchants with very little opportunity to incentivize potential customers beyond traditional public advertising. Moreover, some customers prefer to avoid credit cards—whether for business tracking purpose or otherwise, and so merchants do not reach those customers with advertisements targeted at users of a single credit/charge card payment network and processing system. Existing payment networks are incapable of processing transactions that do not utilize a credit/charge card, in part because the credit/charge card identification number (or token representing the same) helps to identify the payment network for processing a transaction. Similarly, transaction processing systems that do not utilize payment networks do not receive the benefits of wide-availability of payment networks for processing transactions, as these alternative payment processing systems are incapable of closing transactions that use a credit/charge card.

Adding to the above-mentioned technical challenges, legacy merchants are hesitant to change their point-of-sale model. Adding new equipment at a point-of-sale location may be a nonstarter, because merchants may not have physical space to add a new device. Adding new software to existing point-of-sale devices at merchants may also be a nonstarter, because the POS software providers may be unwilling to open the firmware of POS devices to allow new software to be installed. And replacing the existing devices at merchants with new, more feature-rich devices is also typically a non-starter, because of the expense involved in swapping equipment, the required training time for cashiers to use the new machinery, and some individuals' aversion to change may prevent them from looking to replace functional machinery. So any technology that provides more flexible payment methods will need to be backwards compatible with existing POS technologies (backwards compatible with both hardware and software of existing POS technologies) and payment networks.

### Technical Solutions

To overcome the above-mentioned technical challenges, a system is provided that is capable of communicating with merchants and with payment networks to settle transactions occurring using multiple transaction channels. Closed loop transaction channels are provided with merchants using mobile devices operated at a merchant location and which communicate transaction details directly with a remote computing system. These closed loop transactions may rely on one-time use tokens that are associated with a purchaser account so that the transaction is easily referenced to the purchaser's account. The system also communicates with a payment network, so that transactions at any merchant having access to the payment network can be settled. The system stores payment instrument identifiers within the purchaser's account data, so that transactions occurring via the open-loop payment network can also be linked with the purchaser's account.

By providing a system having features for settling both open-loop and closed-loop transactions, merchants can attract potential purchasers by providing discounts/offers to only those purchasers using the closed-loop transaction system (e.g., those purchasers may utilize a mobile device application associated with the closed loop transaction system to search for merchants and/or to request one-time use tokens). Merchants do not need to alienate purchasers that do not use the closed-loop transaction system, by providing those purchasers with other offers/discounts. The system pre-processes and normalizes data received from the closed-loop transaction channel and the open-loop transaction channel so that a single purchaser account is usable for transactions occurring in either channel. Merchants are not required to substantially change their POS set-up, and payment networks do not need to alter their operating model, but merchants are given greater flexibility for attracting purchasers, and purchasers are given access to more payment methods while retaining access to multiple offers/discounts.

### Example Operation

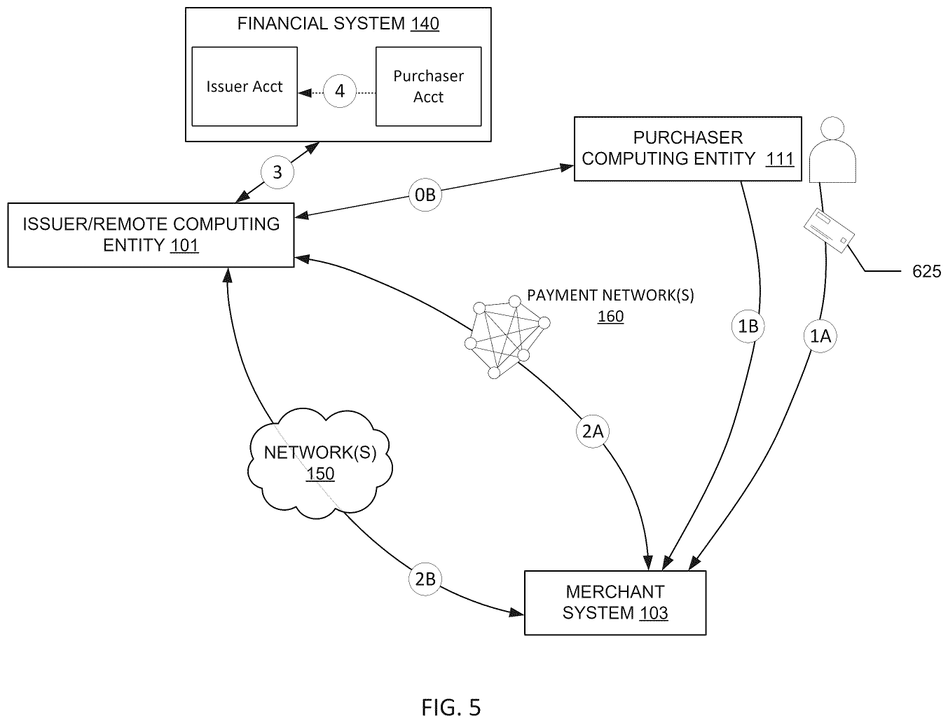

FIG. 5 illustrates an example data flow among computing entities as discussed herein. As shown in FIG. 5, the issuer/remote computing entity 101 comprises two transaction channels—an open loop transaction channel configured to accept transaction data provided by a payment network 160, and a closed loop transaction channel configured to accept transaction data provided as a part of a closed loop transaction. By providing the issuer/remote computing entity 101 with multiple transaction channels, the issuer/remote computing entity 101 provides backwards compatibility with existing payment networks 160 and existing POS systems operating as a part of merchant systems 103 while still providing new and advanced features for merchants to accept payment according to multiple transaction types and to provide merchants with the ability to customize offers/discounts provided to potential purchasers.

Two process flows are demonstrated in FIG. 5. While the issuer/remote computing entity 101 is configured to accept transactions according to either process flow, it should be understood that both process flows will not occur simultaneously, for a single transaction. For example, one purchaser may choose to use the open-loop transaction flow (e.g., by presenting a credit/charge card), and a second purchaser may choose to use the closed-loop transaction flow (e.g., by presenting a one-time use token). Where these process flows differ, FIG. 5 illustrates multiple flow paths between entities (one flow path designated with an “A” and the other flow path designated with a “B”). Where these flow paths converge, FIG. 5 illustrates only a single flow path.

Before discussing each flow path in detail, it should be understood that the issuer/remote computing entity 101 is specially configured to be capable of accepting transactions beginning using either flow path. The issuer/remote computing entity 101 is configured with application program interfaces (APIs) or other communication interfaces for receiving transaction data from a payment network 160. In certain embodiments, the payment network 160 transmits transaction data using an encrypted data communication process. In those embodiments, the issuer/remote computing entity 101 comprises cryptographic keys to decipher encrypted data received from the payment network 160. Moreover, certain data, such as a payment instrument identifier, may be represented with a token that cannot be deciphered/translated into the original payment instrument identifier. The issuer/remote computing entity 101 is configured to determine a corresponding payment instrument identifier based on a received token, using cryptographic algorithms and/or by communicating with the payment network 160 using one or more additional communications. The remote computing entity 101 is thereby capable of correlating the transaction data received from the payment network 160 with a purchaser account stored at the remote computing entity 101, so that the remote computing entity 101 is able to communicate with a financial system 140 to request transfer of funding from the appropriate purchaser account. In certain embodiments, the remote computing entity 101 is configured for identifying discounts to be applied to a transaction based on the received transaction data, even if the transaction data does not reflect those discounts. For example, the remote computing entity 101 looks-up a discount based at least in part on a portion of the transaction data—the discount may be identified using a payment instrument identifier, a one-time use token, a merchant identifier, a purchaser identifier, and/or the like.

The issuer/remote computing entity 101 comprises a second transaction channel specifically configured for receiving transaction data of closed loop transactions. As discussed in greater detail herein, the issuer/remote computing entity 101 generates a one-time use token and stores the one-time use token together with the purchaser account, so that the issuer/remote computing entity 101 is capable of correlating transaction data comprising the one-time use token with a purchaser account, and to communicate appropriate instructions with the financial system 140 to transfer funds from the appropriate purchaser financial account. The issuer/remote computing entity 101 may utilize a different form of encryption for the closed loop transactions, however the issuer/remote computing entity 101 need not share cryptographic keys or other data regarding the encryption algorithm with any third parties due to the closed-loop nature of the transaction data. Transaction data received from a merchant system 103 may be provided using an application provided by and managed by the issuer/remote computing entity 101 (e.g., either a web-based application, or a stand-alone application installed on a device at the merchant location without open-source access to the underlying code of the application).

Recognizing that transaction data provided through each transaction channel will have different content and formatting, the issuer/remote computing entity 101 is configured to preprocess the transaction data to enable the issuer/remote computing entity 101 to provide a uniform storage of transaction data for each purchaser. This enables the issuer/remote computing entity 101 to provide user-friendly graphical user interfaces providing a ledger of transaction for the purchasers, and enables the user of machine learning to provide advanced functions to purchasers and merchants.

With reference to FIG. 5, a purchaser (and corresponding purchaser computing entity 111), first seeks to initiate a transaction using a payment instrument 625 (e.g., a credit/charge card). The payment instrument 625 uses a payment network 160 to complete transactions with any merchant capable of communicating with the payment network 160 for transaction processing. This is an open-loop transaction. The purchaser chooses products/services for purchase, requests a transaction with the merchant (and merchant system 103), and presents the payment instrument 625, as shown at line 1A of FIG. 5. For fuel purchases, the purchaser may present the payment instrument 625 via a POS terminal or at a fuel pump. The total transaction amount may not be known at the time the payment instrument 625 is presented (e.g., when presented prior to dispensing fuel into a vehicle). Therefore, the merchant system 103 uses the payment network 160 to request a preauthorization from the issuer/remote computing entity 101. A pre-authorization request is sent from the merchant system 103, though payment network 160, to the issuer/remote computing entity 101. In other instances, the amount of the transaction may be known, and the pre-authorization request may specify the total amount of the transaction. The pre-authorization request includes a payment instrument identifier (or a token representing the same) that enables the issuer/remote computing entity 101 to identify an appropriate purchaser account and to communicate with the financial system 140 to determine if the purchaser's financial account is adequately funded to complete a purchaser for a pre-authorization amount (e.g., a standard amount for any fuel purchase). In this case, adequately funded may refer to current funding—determining whether the purchaser's account has funding within the account that can immediately satisfy the transaction. In other examples, adequately funded may refer to a purchaser credit account—determining whether the purchaser's credit account has an adequately high credit limit remaining so that the financial institution of the financial system 140 is willing to extend credit to the purchaser to cover the transaction value. In certain embodiments, the issuer/remote computing entity 101 may at least partially manage purchaser financial accounts with a particular financial system 140, and therefore the remote computing entity 101 may maintain data indicating the funding in purchaser financial accounts, without separately transmitting a request to the financial system 140. In some embodiments, the financial system 140 may be configured to push data to the remote computing entity 101 when changes to the amount of funding within a purchaser financial account occur.

Upon determining that the purchaser has adequate funding available to cover the transaction (or the pre-authorization amount for the transaction), the issuer/remote computing entity 101 sends a pre-authorization approval through the payment network 160 (using the open-loop transaction channel) to merchant system 103. The merchant system 103 then completes the transaction with the purchaser (e.g., by enabling a fuel dispensing system, in certain embodiments). The merchant system 103 then transmits the final transaction data through the payment network 160 to the issuer/remote computing entity 101, along line 2A in FIG. 5, to enable the issuer/remote computing entity 101 to complete final settlement steps for the transaction. The issuer/remote computing entity provides reimbursement funding to the merchant for the total value of the transaction, less fees collected by the issuer/remote computing entity 101 and/or the payment network 160 using the open-loop communication channel. The final transaction data transmitted to the issuer/remote computing entity 101 comprises the payment instrument identifier, the total value for the transaction (using pricing data stored at the merchant system 103), date/time of the transaction, and a merchant identifier for the transaction. In certain embodiments, the final transaction data additionally comprises itemized data for the transaction (e.g., listing each product/service purchased and the value associated with each listed product/service purchased).

The issuer/remote computing entity 101 determines any discounts that are applicable to the transaction, based at least in part on the merchant identifier, the payment instrument identifier, the date/time of the transaction, the itemized data indicating each product/service purchased, and/or the like. For example, the issuer/remote computing entity 101 queries one or more look-up tables for merchant-specific discounts, purchaser-specific discounts, and/or transaction-specific discounts. These look-up tables may be stored in one or more accounts within memory of the remote computing entity 101 (e.g., a purchaser account, merchant account, and/or the like), or the look-up tables may be stored separately from the accounts. In certain embodiments, a discount may apply to an entire transaction, or may apply to only a single product/service purchased in the transaction. In certain embodiments, a plurality of discounts may apply to a transaction (e.g., each discount may apply to a different product/service purchased in the transaction). In some embodiments, the remote computing entity 101 identifies a plurality of discounts that are applicable in the alternative to a particular transaction. The remote computing entity 101 selects a single discount of the plurality of alternative discounts using criteria stored at the remote computing entity 101.

Once the one or more discounts are determined for the transaction, the issuer/remote computing entity 101 pre-processes the final transaction data received using the open-loop transaction channel from the payment network 160 for storage in a transaction history ledger for the purchaser and for the merchant, and for provision to the financial system 140 to request transfer of funds into the issuer's financial account. In certain embodiments, pre-processing comprises standardizing data fields within the final transaction data and adding additional fields reflecting the determined discount(s) for the transaction. Pre-processing additionally comprises determining a discounted transaction amount that is owed by the purchaser for the transaction. As shown at line 3 of FIG. 5, the issuer/remote computing entity 101 transmits a funding transfer request to the financial system 140 that identifies the purchaser account, the issuer account, and the amount to transfer. The funding transfer request may additionally comprise transaction-specific information, such as date/time of the transaction, the merchant involved in the transaction, and/or the like. This information may be provided to the financial system 140 so that it can be included in a ledger entry for the purchaser's financial account reflecting the transfer to the issuer. In some embodiments, the funding transfer request is encrypted. The funding transfer request causes the financial system 140 to transfer funds from the purchaser's account to the issuer's account.

Now describing the closed-loop transaction process, FIG. 5 illustrates that this process begins before a transaction occurs. At line 0B, the purchaser uses purchaser computing entity 111 to request a one-time use token for a transaction. The purchaser computing entity 111 specifies a merchant for the one-time use token, and specifies the purchaser account for the one-time use token. The remote computing entity 101 receives the request, generates the one-time use token and stores the one-time use token in the purchaser's account together with data indicating the merchant where the one-time use token can be used, the discount (or unit price, if applicable) for one or more products/services that are available by using the one-time use token, and an expiration date/time for the one-time use token. In certain embodiments (where a token may be used more than “one-time”), the data may further specify the number of times that the one-time use token may be used, if applicable. The remote computing entity 101 provides the one-time use token to the purchaser computing entity 111, so that it can be used later.

When the purchaser seeks to initiate a transaction using the one-time use token, the purchaser presents the one-time use token instead of a payment instrument (which is described above). The merchant system 103 receives the one-time use token (in some embodiments, using a separate device, such as a mobile device operable at the merchant's location but electronically connected with other components of the merchant system 103). The merchant system 103 requests pre-authorization of the transaction. However, instead of using the payment network 160 for transmission of pre-authorization (and final transaction data) to the issuer/remote computing entity 101, the merchant system 103 transmits the pre-authorization data using network 150. The transaction data is passed between systems using a closed-loop transaction configuration, and accordingly the issuer/remote computing entity does not use the data transmission and features provided by the payment network 160. Moreover, because the merchant system 103 components used for receiving the one-time use token (and associated transaction data) are part of a closed-loop system managed at least in part by the issuer/remote computing entity 101, the data may be encrypted and/or otherwise transmitted in a secure manner without sharing cryptographic keys/secrets with third parties. The issuer/remote computing entity 101 can manage security end-to-end for the closed-loop data transmissions.

The issuer/remote computing entity 101 receives the pre-authorization request using a closed-loop transaction channel that is separate from the open-loop transaction channel. The issuer/remote computing entity 101 determines whether the single-use token is eligible for use by the purchaser, at the merchant, for the products/services included in the transaction, on the date/time of the proposed transaction. For example, the remote computing entity 101 references data stored with the one-time use token in memory to ensure usage is valid for the proposed transaction. The issuer/remote computing entity 101 then identifies a purchaser financial account (or a purchaser credit account, if applicable) associated with a purchaser account of the purchaser of the transaction and ensures that the purchaser financial account has adequate funding to complete the transaction (or a standard pre-authorization amount, if the final transaction value is not known). This funding verification is analogous to the process discussed above for open-loop transaction processing.

When the issuer/remote computing entity 101 determines that the one-time use token is valid for use for the proposed transaction and the purchaser account has adequate funding for completing the purchase, the issuer/remote computing entity 101 transmits pre-authorization approval using the closed-loop transaction channel to the merchant system 103. The merchant system 103 receives the pre-authorization approval and completes the transaction (e.g., by enabling use of the fuel dispensing system) and generates final transaction data.

As shown at line 2B, the merchant system 103 transmits the final transaction data to the issuer/remote computing entity 101 using the closed-loop transaction channel that passes outside of payment network 160 and through network 150. The remote computing entity 101 receives the final transaction data, including the one-time use token. The merchant system 103 identifies discounts associated with the one-time use token by identifying data stored together with the one-time use token within memory of the remote computing entity 101. The remote computing entity 101 calculates a discounted transaction value based on the discount identified for use of the one-time use token. In some embodiments, the remote computing entity 101 calculates the discount value on an itemized basis (e.g., per product/service purchased, using unit discounts/pricing associated with the one-time use code). In some embodiments, the remote computing entity 101 calculates the discount value on a gross transaction basis (calculating a single discounted value for the transaction). The single discounted value for the transaction is the amount owed by the purchaser for the transaction. In some implementations, the amount owed by the purchaser for the transaction is less than the final transaction amount provided by the merchant system based on posted prices at the merchant location. However, because the one-time use tokens are used in closed-loop transactions, the merchant system 103 may receive data indicating the discounted transaction value, such that the total transaction value is equal to the discounted transaction value.

The issuer/remote computing entity 101 pre-processes the data in a manner similar to that discussed above in reference to the open-loop transaction processing (except the closed-loop transaction data may differ in format and/or content as compared to that of the open-loop transaction data). As discussed above, the pre-processed data may enable generation of ledger entries for the merchant and/or the purchaser. As shown at line 3 of FIG. 5, the issuer/remote computing entity 101 transmits data to the financial system 140 to request funding is moved from the purchaser financial account to the issuer financial account. As discussed above, the request transmitted to the financial system 140 may include transaction-specific data so that the financial system 140 can provide transaction-specific data within a ledger provided for the purchaser. The financial system 140 moves funding from the purchaser's financial account to the issuer's financial account, as shown at line 4 in FIG. 5. The issuer/remote computing entity 101 transmits funding to the merchant equal to the discounted transaction amount, less fees kept by the issuer.

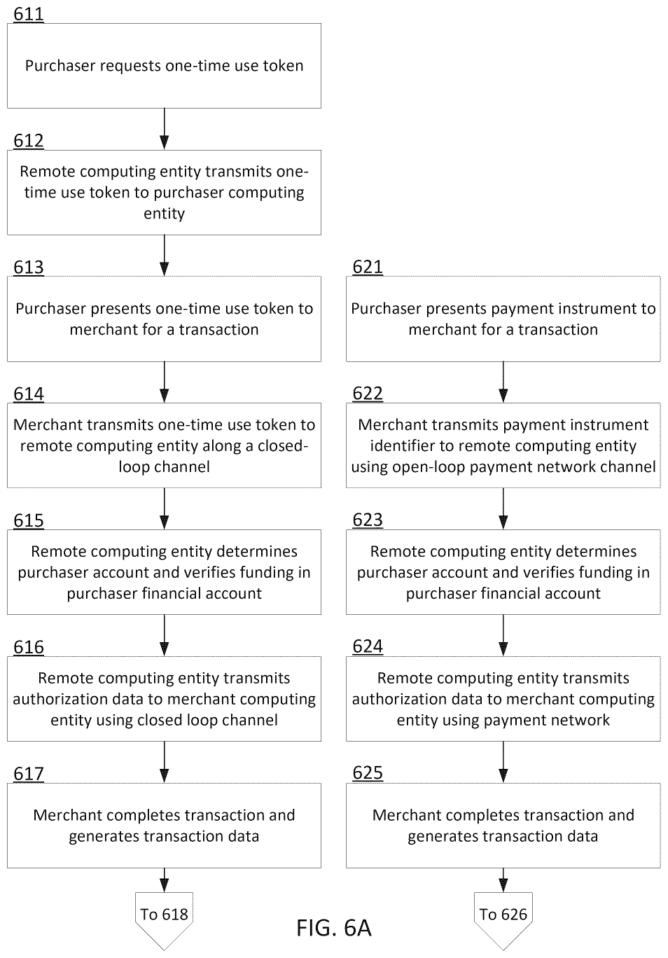

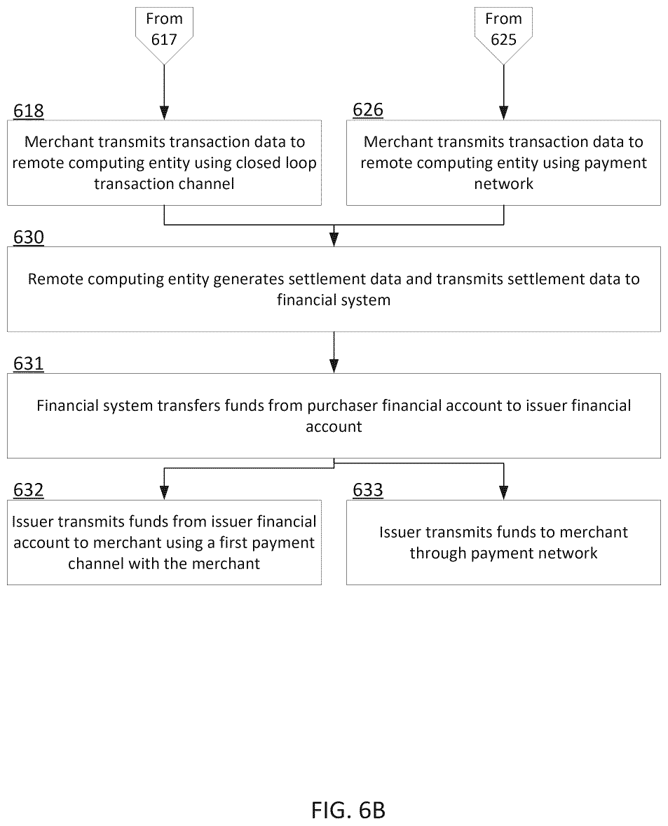

FIGS. 6A-6B is a flowchart showing the methods for processing open-loop and closed-loop transactions. Although these processes are shown in parallel, it should be understood that a single transaction occurs entirely as an open-loop transaction, or entirely as a closed-loop transaction. Multiple transactions may, but need not occur simultaneously. Thus, the remote computing entity 101 is configured to facilitate execution of open-loop and closed-loop transactions occurring simultaneously or at separate times. For the sake of clarity, multiple open-loop transactions may occur simultaneously, or multiple closed-loop transactions may occur simultaneously (e.g., at different merchant locations).

Closed-loop transactions follow the flow path in FIGS. 6A-6B from block 611 to block 618, then to blocks 630 to 631, and finally to block 632. Open-loop transactions follow the flow path from block 621 to block 626, then to blocks 630 to 631 (which are common to both open-loop and closed-loop transactions), and finally to block 633.

Starting with a description of a closed-loop transaction, the process begins as illustrated at block 611, where a purchaser (using a purchaser computing entity 111) requests a one-time use token for making a purchase at merchant. As mentioned above, the one-time use token may be limited to use with a single merchant, and on a single product/service. Single-use tokens may be configured for use with more than one product or with more than one merchant in other embodiments.

At block 612, the remote computing entity receives the request for a one-time use token, generates the requested one-time use token, and transmits the one-time use token to the purchaser computing entity. The purchaser computing entity may store the one-time use token locally for later retrieval during a transaction.

During a transaction with a merchant, the purchaser provides user input to the purchaser computing entity 111 to retrieve the one-time use token to generate a visible representation of the one-time use token on a graphical user interface. The purchaser presents the one-time use token to the merchant (a computing device of the merchant system 103). This may be presented in human-readable text or a machine-readable code (e.g., a barcode, QR code, near-field communication transmission, and/or the like).

At 614, the merchant system 103 transmits the one-time use token to the remote computing entity 101 along a closed-loop transaction channel to ensure the one-time use token is usable for the transaction. The one-time use token may be sent as a part of a pre-authorization request comprising certain elements of transaction data, such as a merchant identifier, a purchaser identifier (if known), the one-time use token, a requested product/service to be purchased, a value and/or quantity of the product/service to be purchased (if known), a date/time of the proposed transaction, and/or the like. The remote computing entity 101 checks to ensure the one-time use token is still active, it is available for use with the merchant and for the products/services to be purchased. The remote computing entity 101 additionally checks funding within a purchaser financial account to ensure the purchaser financial account has adequate funding to satisfy the transaction value (if known) or a standard transaction value (if the final transaction value is not known), as shown at 615.

At 616, the remote computing entity 101 transmits authorization data to the merchant system 103 using the closed-loop transaction channel, after determining that the one-time use token is usable for the proposed transaction and the purchaser financial account has adequate funding to satisfy the transaction. If the remote computing entity 101 determines that the one-time use token is not valid for the transaction, or if the purchaser's financial account cannot satisfy the transaction value, the remote computing entity 101 transmits denial data to the merchant system 103, so that the transaction is ended without completion.

At 617, upon receipt of the authorization data, the merchant completes the transaction (e.g., using the fuel dispensing system) and generates transaction data. Due to the closed-loop environment, the merchant system 103 may know of any discounts applicable to the transaction from the one-time use token, and so the transaction data may comprise data identifying a final transaction value that matches a discounted transaction value owed by the purchaser.

At 618, the merchant transmits the transaction data for the completed transaction to the remote computing entity 101 using the closed-loop transaction channel.

Once the remote computing entity 101 receives the transaction data, the remote computing entity 101 pre-processes and processes the transaction data using steps common to both open-loop and closed-loop transactions, as reflected at Blocks 630-631. The remote computing entity 101 pre-processes the data to a common data format shared between both transaction types. The common data format enables generation of a comingled ledger for both the purchaser and merchant, showing all transactions involving the issuer/remote computing entity 101 for the purchaser or merchant, respectively. In embodiments where the common data format is used to generate a graphical user interface displaying the ledger, each transaction may have a graphical format specific to the type of transaction (e.g., different font colors/styles for each transaction type).

With reference again to FIG. 6A-6B, the remote computing entity 101 generates settlement data for the closed-loop transaction received at 618 based on the transaction data as shown at Block 630. As a part of generating the settlement data for a transaction, the remote computing entity 101 determines one or more discounts applicable to the transaction. Discounts may be identified as a gross discount (e.g., $10 off of a purchase), a percentage discount (e.g., 5% off of a purchase), a discount per product (e.g., 5% off of a purchase of diesel; 10% off beverages), a unit discount (e.g., $0.05 off per gallon of diesel purchased), and/or the like. For closed-loop transactions, the remote computing entity 101 uses the one-time use token to identify a discount applicable to the transaction. In some embodiments, the closed-loop transaction data includes the discount (e.g., the transaction data may reflect a discounted price paid by the purchaser). In other embodiments, the remote computing entity 101 may store a look-up table linking one-time use tokens to the respective discounts, such that the discount may be retrieved and applied to the transaction data when generating the settlement data. For open-loop transactions, the remote computing entity 101 may utilize the payment instrument identifier (or other portions of the transaction data) to identify a purchaser account for the transaction. The purchaser account may store data identifying one or more discounts for the purchaser, and the remote computing entity 101 may retrieve data identifying a discount from the purchaser account to apply the discount to the transaction data when generating the settlement data. In other embodiments, the remote computing entity 101 may utilize the merchant identifier within the transaction data to retrieve a merchant account to identify discount data applicable to transactions executed at a particular merchant and to generate the settlement data using the merchant-specific discount data.

The settlement data comprises data identifying a discounted transaction value owed by the purchaser for the transaction (based on the discount applicable to the transaction, identified as discussed above), identifies the purchaser (or the purchaser's financial account identifier, if known) and the issuer financial account identifier. At Block 631, the financial system transfers the value owed from the purchaser's financial account to the issuer's financial account. In some embodiments, the settlement data may comprise other transaction-specific data, so that the financial system 140 can provide some of the transaction-specific data within a ledger provided to the purchaser (e.g., identifying the merchant, the date/time of the transaction, and/or the like).

Blocks 632-633 illustrate how the merchant is funded for the transaction, which differs depending on whether the transaction was a closed-loop transaction (Block 632) or an open-loop transaction (Block 633). As shown at Block 632, funding is provided to the merchant from the issuer along the closed-loop transaction channel. For example, payment may be provided using ACH or other bank-transfer protocol directly between the issuer's financial account and the merchant's financial account.

As mentioned, open-loop transactions are also illustrated in FIGS. 6A-6B with a flow beginning at 621 when the purchaser presents a payment instrument to a merchant (merchant system 103) for a transaction. As mentioned above, the payment instrument may be a credit/charge card or an encrypted token representing the same (e.g., as may be generated/stored by an electronic wallet on a purchaser computing entity 111), and the merchant system 103 temporarily stores the payment instrument identifier for completing the transaction. The merchant system 103 need not recognize the payment instrument as being associated with the issuer for providing discounts after the transaction is completed.

The merchant system 103 parses the payment instrument identifier and determines the payment network 160 to be utilized for completing the transaction (e.g., a portion of the payment instrument identifier serves to identify a payment network, such as the VISA® network for the payment instrument). At 622, the merchant system 103 transmits the payment instrument identifier along the open-loop transaction channel through the payment network 160 to be received by the remote computing entity 101. The payment instrument identifier may be transmitted as a part of a pre-authorization request comprising certain elements of transaction data, such as a merchant identifier, a requested product/service to be purchased, a value and/or quantity of the product/service to be purchased (if known), a date/time of the proposed transaction, and/or the like. The remote computing entity 101 checks to ensure the payment instrument is still active and to make sure no limitations on usage of the payment instrument are present. The remote computing entity 101 additionally checks funding within a purchaser financial account to ensure the purchaser financial account has adequate funding to satisfy the transaction value (if known) or a standard transaction value (if the final transaction value is not known), as shown at 623.

At 624, the remote computing entity 101 transmits authorization data to the merchant system 103 using the open-loop transaction channel, after determining that the payment instrument is valid and the purchaser financial account has adequate funding to satisfy the transaction. If the remote computing entity 101 determines that the payment instrument is not valid, or if the purchaser's financial account cannot satisfy the transaction value, the remote computing entity 101 transmits denial data to the merchant system 103, so that the transaction is ended without completion.

At 625, upon receipt of the authorization data, the merchant completes the transaction and generates transaction data. Neither the merchant's POS nor the payment network 160 need special configurations to enable the issuer to provide discounts to the purchaser on behalf of the merchant. Therefore, the system and method discussed herein are backwards compatible with existing merchant POS systems. Moreover, the system and method discussed herein are compatible with merchant systems that do not offer discounts through the issuer. Therefore, the payment instrument 625 is usable at merchants that have accounts with the issuer and at merchants that do not have accounts with the issuer. In certain embodiments, the transaction data comprises data identifying a transaction value based on unit prices stored locally at the merchant system 103 for products/services. These prices do not reflect a discounted value charged to the purchaser.

At 626, the merchant transmits the transaction data for the completed transaction to the remote computing entity 101 using the open-loop transaction channel.

After 626, the process moves to the steps discussed in Blocks 630-631. As discussed above, these are common to both the open-loop and closed-loop transactions. Although it should be understood that the format of data provided through the closed-loop transaction channel may differ from the format of data provided through the open-loop transaction channel, and so the program code used for processing and/or pre-processing data may differ for the closed-loop and open-loop transactions. Once the remote computing entity 101 receives the transaction data, the remote computing entity 101 pre-processes and processes the transaction data using steps common to both open-loop and closed-loop transactions, as reflected at Blocks 630-631. The remote computing entity 101 pre-processes the data to a common data format shared between both transaction types. The common data format enables generation of a comingled ledger for both the purchaser and merchant, showing all transactions involving the issuer/remote computing entity 101 for the purchaser or merchant, respectively. In embodiments where the common data format is used to generate a graphical user interface displaying the ledger, each transaction may have a graphical format specific to the type of transaction (e.g., different font colors/styles for each transaction type).

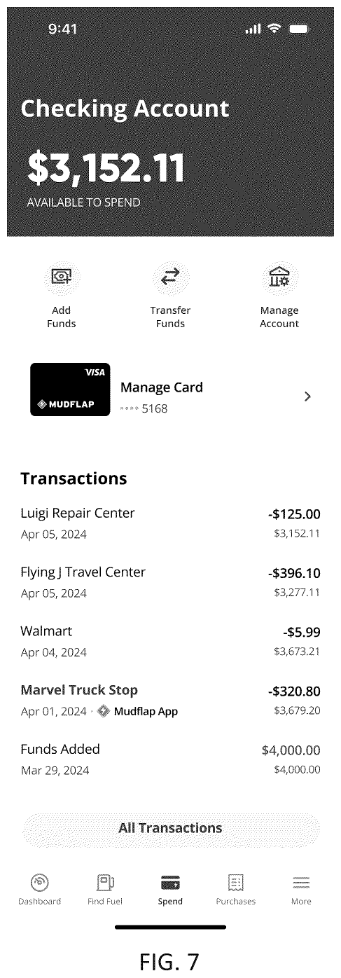

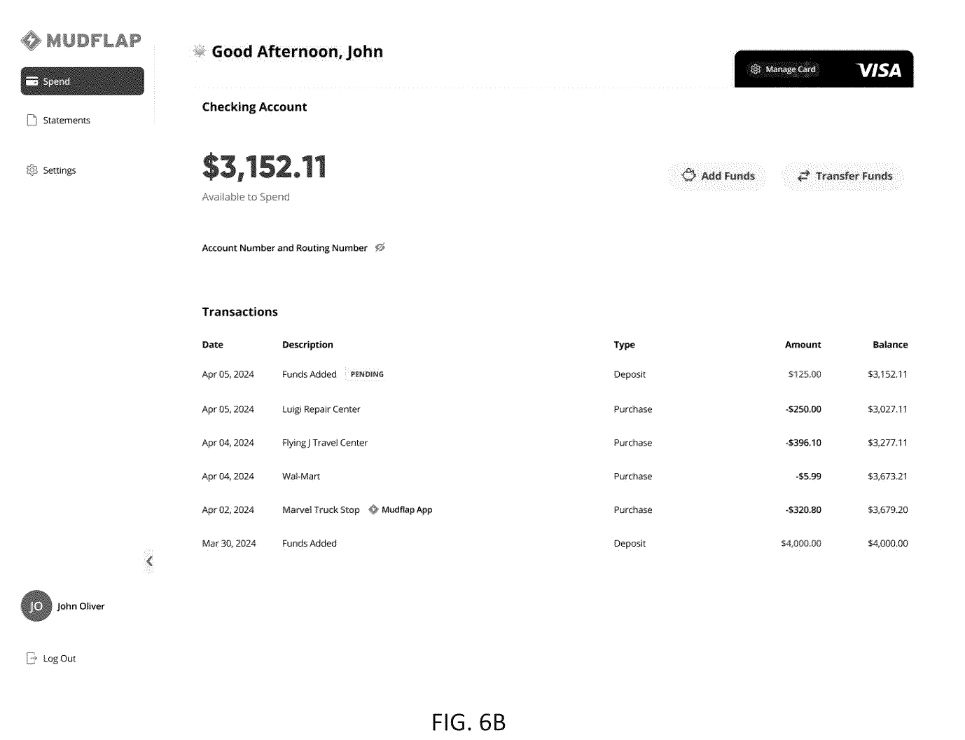

FIGS. 7-8 are example graphical user interfaces displaying an example ledger according to certain embodiments. The screenshot of FIG. 7 reflects a graphical user interface of an executable application operating on a mobile user device (e.g., a smartphone). The screenshot of FIG. 8 reflects a graphical user interface of a web-based application that may be accessible by a purchaser computing entity 111 (e.g., a mobile device, a laptop, and/or the like). As shown in each of FIGS. 7-8, the displayed ledger includes an indication of an amount of funds available in the account, and an indication of each transaction for the account. For each transaction, a date, description, type, and amount are shown. As shown, transactions occurring using a closed loop transaction channel are distinguished from transactions occurring using an open loop transaction channel. In the illustrated embodiment, transactions using the closed loop transaction channel may be designated with a label (in the illustrated example, the label of “Mudflap App” designates closed-loop transactions). It should be understood that other designations may be utilized in other embodiments.

With reference again to FIG. 6A-6B, the remote computing entity 101 generates settlement data for the open-loop transaction received at 626 based on the transaction data as shown at Block 630. The settlement data comprises data identifying a discounted transaction value owed by the purchaser for the transaction, identifies the purchaser (or the purchaser's financial account identifier, if known) and the issuer financial account identifier. At Block 631, the financial system transfers the value owed from the purchaser's financial account to the issuer's financial account. In some embodiments, the settlement data may comprise other transaction-specific data, so that the financial system can provide some of the transaction-specific data within a ledger provided to the purchaser (e.g., identifying the merchant, the date/time of the transaction, and/or the like).

At Block 633, funding is provided to the merchant from the issuer along the open-loop transaction channel, through payment network 160. For example, payment is made to the purchaser for the final transaction value (before discounts), less fees owed to the issuer and/or payment network 160. In this way, the system and method discussed herein is backwards compatible with existing payment networks 160 and POS systems—the amount paid to the merchant can be anticipated by the payment network 160 based on the transaction data passed from the merchant to the issuer through the payment network 160. Therefore, the payment network 160 does not flag the value passed to the merchant as incorrect/fraudulent. To the extent that the merchant owes the issuer based on the value of a discount provided to the purchaser, this additional amount owed by the merchant to the issuer can be provided using alternative payment channels.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

In certain embodiments, the issuer may provide reward credits/points/reimbursements to purchasers for completing transactions. These reward credits/points/reimbursements may be stored in association with a purchaser account, and may be redeemed for later purchases. In some embodiments, the redemption may be limited to certain types of purchases (e.g., fuel purchases only). Moreover, the issuer may work with certain merchants for additional reward purchases, for example, as advertising for the merchants. The additional rewards may be determined based at least in part on the goods/services purchased (e.g., 1 point for every dollar spent on certain types of purchases and 2 points for every dollar spent on other types of purchases) or the additional rewards may be determined for all purchases from a particular vendor (e.g., 2 points for every dollar spent at a particular merchant). In some embodiments, the issuer may identify those transactions eligible for additional rewards, and may request the merchant to reimburse the issuer for the value of the additional rewards.

1. A method for settling transactions using a multi-channel transaction settlement system, the method comprising:
generating, using one or more processors, a single-use token for a purchaser account, wherein the single-use token identifies a discount amount for a closed-loop transaction;
receiving, using the one or more processors, first transaction data using a closed-loop transaction channel, wherein the first transaction data comprises the single-use token;
generating, using the one or more processors, first settlement data at least in part by retrieving purchaser account data from the purchaser account based at least in part on the single-use token and populating the first settlement data having a format for a financial system;
transmitting, using the one or more processors, the first settlement data to the financial system to cause funding to be transferred from a first funding account to a second funding account;
receiving, using the one or more processors, second transaction data using an open-loop transaction channel in communication with a payment network, wherein the second transaction data comprises a payment instrument identifier linked with the purchaser account;
generating, using the one or more processors, second settlement data at least in part by populating the second settlement data from the second transaction data into a format for the financial system; and
transmitting, using the one or more processors, the second settlement data to the financial system to cause funding to be transferred from the first funding account to the second funding account.

2. The method for settling transactions using a multi-channel transaction settlement system of claim 1, further comprising generating the first transaction data based at least in part on user input received from a merchant computing entity as a part of the closed-loop transaction.

3. The method for settling transactions using a multi-channel transaction settlement system of claim 1, wherein the first settlement data comprises authorization data indicating the first settlement data is authorized for transferring funds from the first funding account associated with the purchaser account.

4. The method for settling transactions using a multi-channel transaction settlement system of claim 1, wherein the second transaction data is received using an open-loop transaction channel in communication with a payment network by an application programming interface (API).

5. The method for settling transactions using a multi-channel transaction settlement system of claim 1, wherein the second transaction data comprises L2 data from a payment instrument having the payment instrument identifier.

6. The method for settling transactions using a multi-channel transaction settlement system of claim 1, wherein the first settlement data comprises a transaction type identifier reflecting a closed-loop transaction type and the second settlement data comprises a transaction type identifier comprises a transaction type identifier reflecting an open-loop transaction type.

7. The method for settling transactions using a multi-channel transaction settlement system of claim 1, further comprising: after receipt of the first transaction data or receipt of the second transaction data, verifying funding within the first funding account; and
upon determining the first funding account has insufficient funds to satisfy the first transaction data or the second transaction data, causing the financial system to initiate funding into the first funding account from an external account.

8. A multi-channel transaction settlement system comprising:
a single-use token generator for closed-loop transactions, wherein;
the single-use token generator links a single-use token with a purchaser account stored in memory of the multi-channel transaction settlement system; and
the single-use token identifies a discount amount for a closed-loop transaction;
a closed-loop transaction channel linked with one or more processors, configured to:
receive first transaction data comprising the single-use token;
generate first settlement data at least in part by retrieving purchaser account data from the purchaser account based at least in part on the single-use token and populating the first settlement data having a format for a financial system, wherein the first settlement data identifies a first financial account based at least in part on the purchaser account;
an open-loop transaction channel linked with the one or more processors, configured to:
receive second transaction data comprising a payment instrument identifier of a payment instrument of the purchaser;
generate second settlement data at least in part by populating the second settlement data from the second transaction data into a format for the financial system, wherein the second settlement data identifies the first financial account based at least in part on the purchaser account; and
a financial system channel linked with the one or more processors, configured to transmit the first settlement data and the second settlement data to a financial system to cause the financial system to transfer first funds from the first financial account to a second financial account for the first settlement data and to transfer second funds from the first financial account to the second financial account for the second settlement data.

9. The multi-channel transaction settlement system of claim 8, wherein the closed-loop transaction channel is configured to receive the first transaction data from a merchant computing system.

10. The multi-channel transaction settlement system of claim 8, wherein the open-loop transaction channel is configured to receive the second transaction data using an Application Program Interface (API) from a payment network.

11. The multi-channel transaction settlement system of claim 8, wherein the financial system channel is configured to pre-process the first transaction data and the second transaction data to populate at least a portion of the first settlement data and the second settlement data.

12. The multi-channel transaction settlement system of claim 8, wherein the financial system channel is configured to encrypt the first settlement data and the second settlement data.

13. The multi-channel transaction settlement system of claim 8, wherein the single-use token generator is configured to receive a token generation request from a purchaser computing entity, and wherein the single-use token is liked with the purchaser account based at least in part on the token generation request received from the purchaser computing entity.

14. The multi-channel transaction settlement system of claim 8, wherein the financial system channel is further configured to verify funding within the first financial account and to utilize one of the closed-loop transaction channel or the open-loop transaction channel to transmit authorization data based at least in part on results of the funding verification.

15. The multi-channel transaction settlement system of claim 14, wherein the financial system channel is further configured to, upon determining that the first financial account has insufficient funds to satisfy the first transaction data or the second transaction data, cause the financial system to initiate funding into the first funding account from an external account.

16. The multi-channel transaction settlement system of claim 8, wherein the financial system channel is further configured to populate at least a portion of the first settlement data and the second settlement data with a transaction type identifier, wherein the first settlement data is populated with a transaction type identifier reflecting a closed-loop transaction type, and the second settlement data is populated with a transaction type identifier reflecting an open-loop transaction type.

17. A computer program product comprising a non-transitory computer readable medium having computer program instructions stored therein, the computer program instructions, when executed by a processor, cause the processor to:
generate a single-use token for a purchaser account, wherein the single-use token identifies a discount amount for a closed-loop transaction;
receive first transaction data using a closed-loop transaction channel, wherein the first transaction data comprises the single-use token;
generate first settlement data at least in part by retrieving purchaser account data from the purchaser account based at least in part on the single-use token and populating the first settlement data having a format for a financial system;
transmit the first settlement data to the financial system to cause funding to be transferred from a first funding account to a second funding account;
receive second transaction data using an open-loop transaction channel in communication with a payment network, wherein the second transaction data comprises a payment instrument identifier linked with the purchaser account;
generate second settlement data at least in part by populating the second settlement data from the second transaction data into a format for the financial system; and
transmit the second settlement data to the financial system to cause funding to be transferred from the first funding account to the second funding account.

18. The computer program product of claim 17, wherein the computer program instructions, when executed by the processor, further cause the processor to transmit the first transaction data based at least in part on user input received from a merchant computing entity as a part of the closed-loop transaction.

19. The computer program product of claim 17, wherein the first settlement data comprises authorization data indicating the first settlement data is authorized for transferring funds from the first funding account associated with the purchaser account.

20. The computer program product of claim 17, wherein the second transaction data is received using an open-loop transaction channel in communication with a payment network by an application programming interface (API).

21. The computer program product of claim 17, wherein the second transaction data comprises L2 data from a payment instrument having the payment instrument identifier.

22. The computer program product of claim 17, wherein the first settlement data comprises a transaction type identifier reflecting a closed-loop transaction type and the second settlement data comprises a transaction type identifier comprises a transaction type identifier reflecting an open-loop transaction type.

23. The computer program product of claim 17, wherein the computer program instructions, when executed by the processor, further cause the processor to after receipt of the first transaction data or receipt of the second transaction data, verify funding within the first funding account; and upon determining the first funding account has insufficient funds to satisfy the first transaction data or the second transaction data, cause the financial system to initiate funding into the first funding account from an external account.

24. The method of claim 1, wherein the discount amount comprises one of: (a) a gross discount amount, (b) a per product discount amount, (c) a per unit discount amount, or (d) a percentage discount.
